(19) United States
(12) Patent Application Publication
(10) Pub. No.: US 2024/0296358 A1
(43) Pub. Date: Sep. 5, 2024

(54) SYSTEMS AND METHODS FOR A COUPLED PLAY, DRIVE, AND MATCH OUTCOME PREDICTION SYSTEM FOR LIVE SPORTS

(71) Applicant: STATS LLC, Chicago, IL (US)

(72) Inventors: Lucas Haupt, Chicago, IL (US); Evan Boyd, Chicago, IL (US); Matthew Scott, Chicago, IL (US); Patrick Joseph LUCEY, Chicago, IL (US)

(73) Assignee: Stats LLC, Chicago, IL (US)

(21) Appl. No.: 18/593,110

(22) Filed: Mar. 1, 2024

Related U.S. Application Data
(60) Provisional application No. 63/488,318, filed on Mar. 3, 2023.

(51) Int. Cl. G06N 7/01

(52) U.S. Cl. CPC G06N 7/01

(57) ABSTRACT

A method for generating coupled play, drive, and game outcome predictions for a sporting event, the method including: inputting features for a sporting event into an initial model, the input features including historical game data and in-game data; determining a predicted outcome for at least one upcoming play with the initial model; determining, using the input features and predicted outcome, a predicted probability of each team winning the sporting event; and determining a probability of success for an action in the at least one upcoming play of the sporting event.

### CROSS-REFERENCE TO RELATED APPLICATIONS

This application claims the benefit of U.S. Provisional Patent Application No. 63/488,318 filed Mar. 3, 2023, the entire contents of which are incorporated herein by reference for all purposes.

### TECHNICAL FIELD

Various aspects of the present disclosure relate generally to machine learning for sports applications. In particular various aspects relate systems and methods for to machine learning techniques for coupled play, drive, and game outcome predictions for a sporting event.

### BACKGROUND

With an increased popularity in sports, there is an increased desire to have accurate granular predictions of events during a sporting event. For example, having a probability of a team winning a sporting event in a given sport (e.g., American Football), can be of particular interest for members of the media, broadcast (whether on the primary feed, or a second screen experience), as well as fans, sportsbook, and fantasy/gamification applications. Further, in many cases, such predictions/probabilities can be impacted as the game progresses.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for generating coupled play, drive, and game outcome predictions for a sporting event, the method including: inputting features for a sporting event into an initial model, the input features including historical game data and in-game data; determining a predicted outcome for at least one upcoming play with the initial model; determining, using the input features and predicted outcome, a predicted probability of each team winning the sporting event; and determining a probability of success for an action in the at least one upcoming play of the sporting event.

In some aspects, the techniques described herein relate to a method, wherein the in-game data comprises at least one of a time left for a remaining portion of the sporting event, a current point total, a current point differential, a current down and distance to go, a number of timeouts remaining, and/or a team in possession.

In some aspects, the techniques described herein relate to a method, wherein the historical game data includes a repository of historical team and player data for one or more sporting events.

In some aspects, the techniques described herein relate to a method, wherein the input model includes: a play probability model, the play probability model being configured to predict a probability of a particular play outcome occurring in the sporting event; a drive score probability model, the drive score probability model being configured to generate a probability of a particular score outcome occurring on a drive in the sporting event; and a drive remaining model, the drive remaining model being configured to predict a number of remaining drives for each team in the sporting event.

In some aspects, the techniques described herein relate to a method, wherein, the predicted outcome includes: the probability of the particular play outcome occurring in the sporting event, the probability of the particular score outcome occurring on the drive in the sporting event, and/or the predicted number of remaining drives for each team in the sporting event.

In some aspects, the techniques described herein relate to a method, wherein the predicted outcome for at least one upcoming play includes each of a set of play outcomes and a corresponding probability of each of the set of play outcomes being performed based on a current down and yardage from a first down.

In some aspects, the techniques described herein relate to a method, wherein predicted outcome for the drive includes each of a set of drive outcomes and a corresponding probability of each of the set of drive outcomes based on a number of yards from a goal line.

In some aspects, the techniques described herein relate to a method, wherein the play probability model includes a random forest classifier, wherein the drive score probability model includes a multi-layer perceptron, and the drive remaining model includes a multi-layer perceptron.

In some aspects, the techniques described herein relate to a method, further including: generating an expected number of points to be scored on a particular drive in the sporting event using an expected points model, the expected points model using the outcome of the drive score probability model to generate the expected number of points.

In some aspects, the techniques described herein relate to a method, wherein the probability of each team winning the sporting events is determined by a live win probability model, the live win probability model including a multi-layer perceptron, the live win probability model receiving outputs from the drive score probability model and drive remaining model.

In some aspects, the techniques described herein relate to a method, wherein the sporting event is an American football game, wherein the at least one upcoming play is a two-point conversion in the American football game, and wherein the probability of success for the two-point conversion is determined by a two-point predictor, the two-point predictor performing the steps of: identifying each of two potential actions capable of being performed, the two potential actions including performing an extra point kick and performing an offensive play after scoring of a touchdown; deriving a success rate of each potential action using the predicted outcome for the at least one upcoming play; and deriving an updated win percentage of each potential action using the predicted probability of each team winning, wherein the success rate and the updated win percentage of each potential action are used to update the predicted probability of each team winning.

In some aspects, the techniques described herein relate to a method, wherein the sporting event is an American football game, wherein the at least one upcoming play is a fourth-down play in the American football game, and wherein the probability of success for the fourth-down play is determined by a fourth down model, the fourth down model performing the steps of: identifying each of three potential actions capable of being performed, the actions including performing a punt, a field goal attempt, or performing an offensive play; deriving a success rate of each potential action using the predicted outcome for the at least one upcoming play; and deriving an updated win percentage of each potential action using the predicted probability of each team winning, wherein the success rate and the updated win percentage of each potential action are used to update the predicted probability of each team winning.

In some aspects, the techniques described herein relate to a method, further including: obtaining updated in-game data during the sporting event; and updating the predicted outcome of the sporting event.

In some aspects, the techniques described herein relate to a system for generating coupled play, drive, and game outcome predictions for a sporting event, the system including: a non-transitory computer readable medium configured to store processor-readable instructions; and a processor operatively connected to the non-transitory computer readable medium, and configured to execute the instructions to perform operations including: inputting features for a sporting event into an initial model, the input features including historical game data and in-game data; determining a predicted outcome for at least one upcoming play with the initial model; determining, using the input features and predicted outcome, a predicted probability of each team winning the sporting event; and determining a probability of success for an action in the at least one upcoming play of the sporting event.

In some aspects, the techniques described herein relate to a system, wherein the in-game data comprises at least one of a time left for a remaining portion of the sporting event, a current point total, a current point differential, a current down and distance to go, a number of timeouts remaining, and/or a team in possession.

In some aspects, the techniques described herein relate to a system, wherein the historical game data includes a repository of historical team and player data for one or more sporting events.

In some aspects, the techniques described herein relate to a system, wherein the input model includes: a play probability model, the play probability model being configured to predict a probability of a particular play outcome occurring in the sporting event; a drive score probability model, the drive score probability model being configured to generate a probability of a particular score outcome occurring on a drive in the sporting event; and a drive remaining model, the drive remaining model being configured to predict a number of remaining drives for each team in the sporting event.

In some aspects, the techniques described herein relate to a system, wherein the predicted outcome includes: the probability of the particular play outcome occurring in the sporting event, the probability of the particular score outcome occurring on the drive in the sporting event, and/or the predicted number of remaining drives for each team in the sporting event.

In some aspects, the techniques described herein relate to a non-transitory computer readable medium configured to store processor-readable instructions, wherein when executed by a processor, the instructions perform operations including: inputting features for a sporting event into an initial model, the input features including historical game data and in-game data; determining a predicted outcome for at least one upcoming play with the initial model; determining, using the input features and predicted outcome, a predicted probability of each team winning the sporting event; and determining a probability of success for an action in the at least one upcoming play of the sporting event.

In some aspects, the techniques described herein relate to a non-transitory computer readable medium, wherein the input model includes: sa play probability model, the play probability model being configured to predict a probability of a particular play outcome occurring in the sporting event; a drive score probability model, the drive score probability model being configured to generate a probability of a particular score outcome occurring on a drive in the sporting event; and a drive remaining model, the drive remaining model being configured to predict a number of remaining drives for each team in the sporting event.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 is a block diagram of an exemplary tracking and analytics environment, in accordance with an aspect.

FIG. 2A is a block diagram of a prediction environment, according to one or more embodiments.

FIG. 2B is a block diagram of additional models within the prediction environment, according to one or more embodiments.

FIG. 3 is a flow diagram of an exemplary method for determining a probability of success for an action in a specific play of a sporting event, according to one or more embodiments.

FIG. 4 is a block diagram of the prediction environment, according to one or more embodiments.

FIG. 5 is a flow diagram of an exemplary fourth down prediction module, according to one or more embodiments.

FIG. 6 is an exemplary output of a fourth down prediction module, according to one or more embodiments.

FIG. 7 is a flow diagram of an exemplary extra-point attempt prediction module, according to one or more embodiments.

FIG. 8 is an exemplary output of an extra-point attempt prediction module, according to one or more embodiments.

FIG. 9A-9B are exemplary outputs of model performance of a play probability module, according to one or more embodiments.

FIG. 9C is an exemplary output of model performance of a drive score probability module, according to one or more embodiments.

FIG. 9D is an exemplary output of model performance of a drive remaining module, according to one or more embodiments.

FIG. 9E is an exemplary output of model performance of a live win probability module, according to one or more embodiments.

FIG. 9F-9G are exemplary outputs of model performance of a punt field position module, according to one or more embodiments.

FIG. 9H-9I are exemplary outputs of model performance of field goal success module, according to one or more embodiments.

FIG. 9J-9K are exemplary outputs of model performance of a go-for-it success module, according to one or more embodiments.

FIG. 9L is an exemplary output of model performance of an extra point kick success module, according to one or more embodiments.

FIG. 9M-9N are exemplary outputs of model performance of a two-point conversion success probability module, according to one or more embodiments.

FIG. 10A-10B are exemplary outputs of an expected points added module, according to one or more embodiments.

FIG. 11 is an exemplary output from the live win probability model, according to one or more embodiments.

FIG. 12 is an example output of the win-probability module during the course of a sporting event, according to one or more embodiments.

FIGS. 13A-13B are example outputs depicting drive and play contextual data during a game, according to one or more embodiments.

FIG. 14 is an example output of a live-win probability module, according to one or more embodiments.

FIG. 15 illustrates an example fourth down predictor and a go-for-two predictor, according to one or more embodiments.

FIG. 16 is an example output illustrating model performance of the drive probability module, according to one or more embodiments.

FIG. 17 is an example output for a model performance of a live win probability module, according to one or more embodiments.

FIG. 18 depicts a flow diagram for training a machine learning model, in accordance with an aspect.

FIG. 19 depicts an example of a computing device, in accordance with an aspect.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to machine learning for sports applications. In particular various aspects relate systems and methods for to machine learning techniques for coupled play, drive, and game outcome predictions for a sporting event.

In various sports, such as American football, characteristics of each individual game can be processed to derive a probability of each team winning. For example, during the course of the game, a live win probability for each team can be generated using data from a completed portion of the game and characteristics of each team. For example, a live win probability model can generate a probability of each outcome (e.g., team A winning, team B winning, a draw) by simulating a remainder portion of the game a number of times. The live win probability model can continually or periodically update probabilities of each outcome as the game progresses and more in-game data is obtained.

However, many existing live win probability models can be unreliable as a useful indicator of performance and a predicted outcome. For example, existing live win probability model may only provide a binary output of whether the home team or away team will win the game. These existing models are not robust enough to generate other insights, such as the likelihood the game will go into overtime.

Further, some live prediction models do not provide context for its output, which may provide a misleading narrative of the current game situation. For example, a team on the 1-yard line in a game may be very likely to score on that play and/or drive. Current models may be unable to account for such context and thus fail to capture contextual data specific to a drive/play during the game.

One or more embodiments disclosed herein may include a system and/or method configured to determine a probability of success for an action during a specific play of a sporting event and the influence of that play on the game outcome. The system may be configured to receive, as input features, including historical game data and in-game data. The received data may be input into a set of initial models to determine a predicted outcome. The predicted outcomes may include the probability of a play succeeding, the probability of scoring a particular amount on a current drive, and the amount of drives left for each time in the sporting event. The system may then, using the received data and the predicted outcome, determine a live win probability for each team. Using the live win probability and one or more additional models, the system may be configured to determine a probability of success for a particular action in a specific play such as a fourth-down play and two-point conversion player in a game.

One or more embodiments disclosed herein may provide an enhanced prediction system which connects predictions at the play/drive level to feed a live-win-probability prediction to generate the likelihood that a team will win/lose or tie within regulation. This may also drive final score total and spread totals (e.g., a predicted score differential), as well as suggested fourth down and two-point conversion plays. The prediction system as described herein can implement multiple models to generate various insights, such as play/drive predictions, final score and spread prediction, live-win probability predictions, and supplemental predictions (e.g., 4th down and go-for-two predictors). The insights generated by the prediction system can be used to drive various prediction resources, such as live predictions and/or season simulators, for example.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

While American football and various aspects relating to American football (e.g., a predicted fourth down and two point conversion success rates) are described in the present aspects as illustrative examples, the present aspects are not limited to such examples. For example, the present aspects can be implemented for other sports or activities, such as soccer, basketball, baseball, hockey, golf, tennis, team sports, individual sports, and so forth.

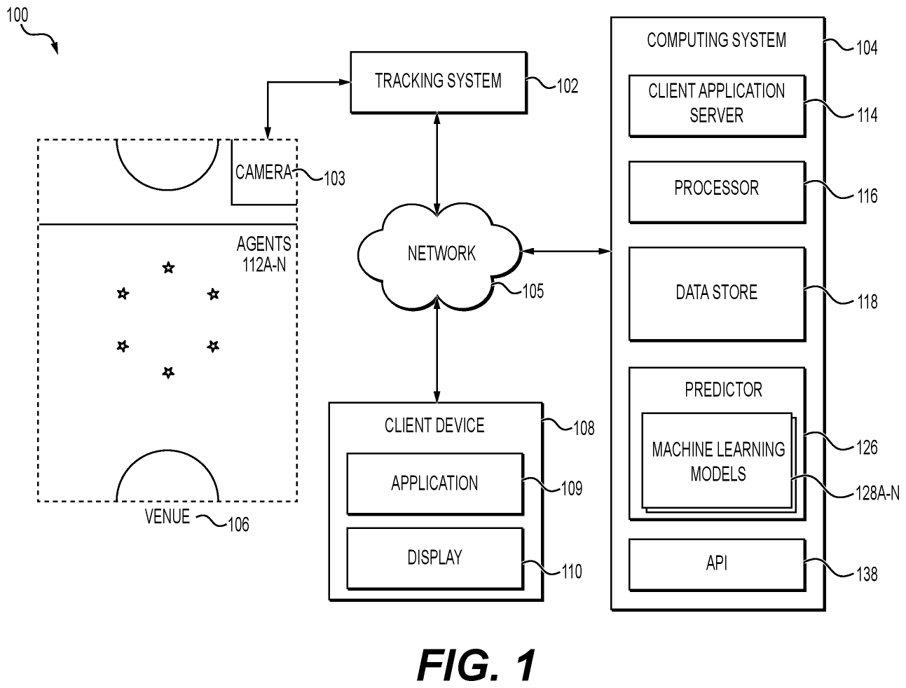

FIG. 1 is a block diagram illustrating a tracking and analytics environment 100, according to example aspects. Environment 100 includes tracking system 102, computing system 104, and client device 108 connected via network 105. In the example depicted, tracking system 102 obtains various attributes of game play (e.g., touchdowns, field goals, passes, rushes, tackles, first downs, turnovers, position information, object information, trends, etc.), and transmits the attributes across network 105 to computing system 104, where one or more machine learning systems can determine one or more predictions related to a sporting event, including, but not limited to: a probability of a play outcome, a probability of a particular drive's outcome, a probability of drives remaining for each team, a probability of each team's win percentage, a predicted expected points added per player or team, a probability of success of a two point conversion, a probability of converting a fourth down-attempt, a predicted punt field position, a predicted field goal success probability, a predicted field position after attempting a fourth down play, and a predicted point after kick success probability.

Tracking system 102 may be positioned in, adjacent to, or near a venue 106. Non-limiting examples of venue 106 include stadiums, fields, pitches, and courts. Venue 106 includes agents 112A-N (e.g., players, objects, officials, etc.). Tracking system 102 may be configured to record the motions and actions related to agents 112A-N on the playing surface, which may include objects of relevance (e.g., ball, referees, etc.). Although environment 100 depicts agents 112A-N generally as players, it will be understood that in accordance with certain implementations, agents 112A-N may correspond to players, objects, markers (e.g., playing surface markers), officials, and/or the like.

In some aspects, tracking system 102 may be an optically-based system using, for example, using camera 103. While one camera is depicted, additional cameras are possible. For example, a system of six stationary, calibrated cameras, which project the three-dimensional locations of players and the ball onto a two-dimensional overhead view of the court may be used.

In another example, a mix of stationary and non-stationary cameras may be used to capture motions of all agents 112A-N on the playing surface as well as one or more objects or relevance. Utilization of such tracking system (e.g., tracking system 102) may result in many different camera views of the court (e.g., high sideline view, free-throw line view, huddle view, face-off view, end zone view, etc.). In some aspects, tracking system 102 may be used for a broadcast feed of a given match. In such aspects, each frame of the broadcast feed may be stored in a game file. In some aspects, the game file may further be augmented with other event information corresponding to event data, such as, but not limited to, game event information (touchdown, field goal, first down, run, pass, tackle, turnover, etc.) and context information (current score, time remaining, etc.). Tracking system 102 may capture attributes based on a broadcast feed, event data (e.g., user annotated data or system annotated data),

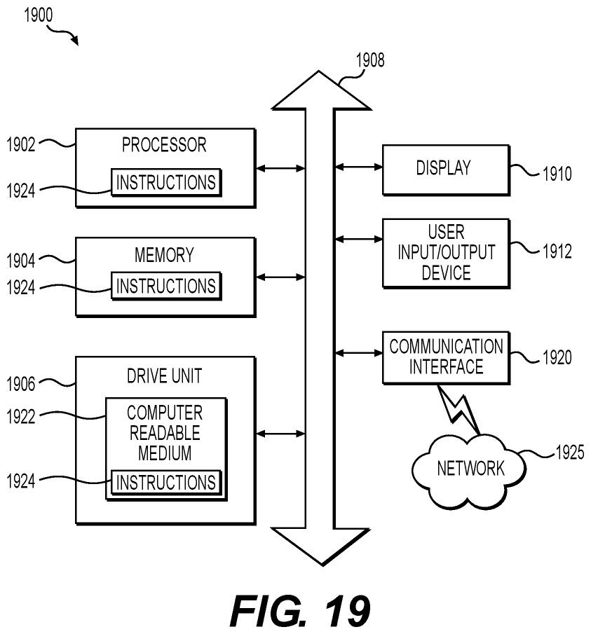

Tracking system 102 may be configured to communicate with computing system 104 via network 105. Computing system 104 may be configured to manage and analyze the data captured by tracking system 102. Computing system 104 may include a web client application server 114, a pre-processing agent 116 (e.g., processor), a data store 118, and a third-party Application Programming Interface (API) 138. An example of computing system 104 is depicted with respect to FIG. 19.

Pre-processing agent 116 may be configured to process data retrieved from data store 118 or tracking system 102 prior to input to predictor 126. The pre-processing agent 116 and/or predictor 126 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store different kinds of data (e.g., in one or more formats). In an example, data store 118 can store raw tracking data received from tracking system 102. The data store 118 may include historical game data, in-game data, and/or outputs derived from any of the models as described herein. The historical data may include a repository of historical team and player data for one or more sporting events. This may include pre-game statistical odds of which team is favored to win, pre-game predicted score totals and point differentials. Historical team data may include all of the team's wins and losses vs respective opponents, the total goals on the year, the total assists on the year, the record vs respective teams over a period of time, the date of all games, the attendance per game, whether particular games are home/away, etc. Historical player data may include rush yards, rush yard per game, rush yards per carry, rushing touchdowns, fumbles, receiving yards, receiving yards per game, receiving yards per catch, pass yards, receiving touchdowns, pass yards per game, pass yards per attempt, pass touch downs, pass interceptions, tackles, forced fumbles, tackles for a loss, sacks, pass blocks, field goals made and attempted at particular distances, extra-point field goal statistics, kick return yards, punt return yards, kick return touchdowns, and punt return touchdowns. The in-game data (e.g., features) may include any of a time left for a remaining portion of the sporting event, a current point total, a current point differential, a current down and distance to go to a first down, a number of timeouts remaining, a team in possession, yards from goal, and position on field.

Predictor 126 includes one or more machine-learning models 128A-N. The one or more machine-learning models may include a random forest classifier, multi-layer Perceptron, and/or logistic regression techniques. The one or more machine-learning models 128A-N may be configured to receive one or more features and to output a prediction related to the sporting event.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

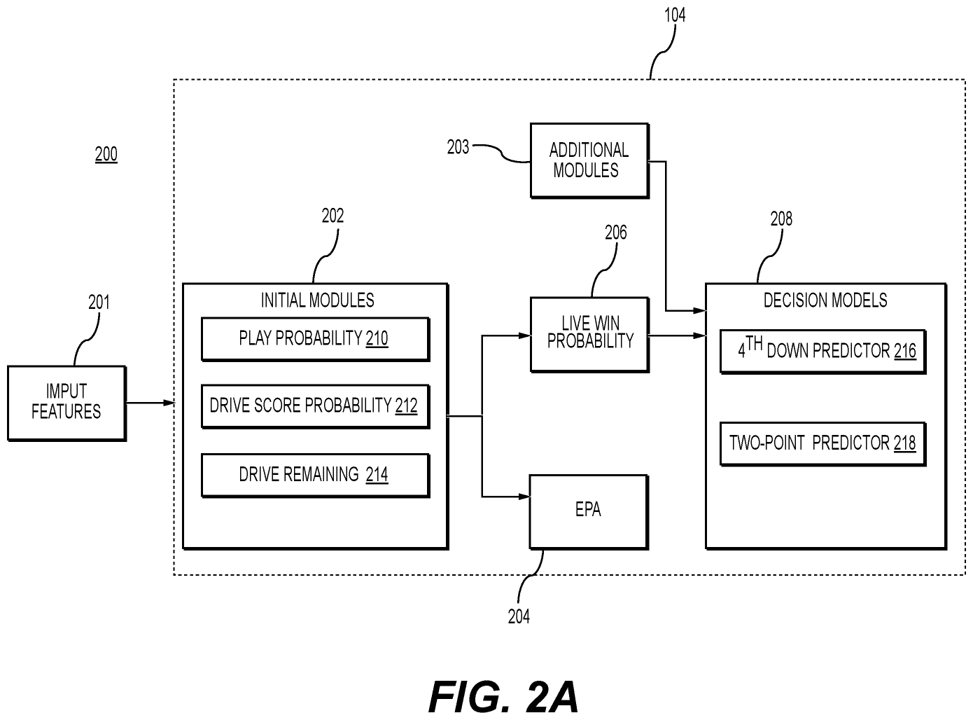

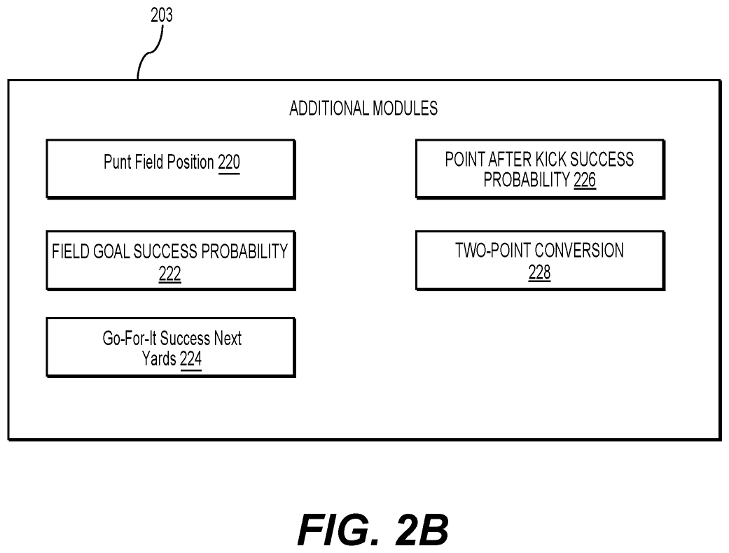

FIG. 2A is a block diagram of the prediction environment 200, according to one or more embodiments. The prediction environment 200 may determine a probability of success for an action in a specific play of a sporting event. The prediction environment 200 may be configured to receive input features (e.g., historical game data and in-game data) and to determine one or more predictions. The prediction environment 200 may include initial modules 202, additional modules 203, an expected point model (EPA) module 204, a live win probability (LWP) module 206, and decision modules 208. One or more of the modules (initial modules 202, additional modules 203, expected point model (EPA) module 204, LWP module 206, and decision modules 208) of the prediction environment 200 may be located within the computing system 104. One or more of the modules may be located on an external server accessed through network 105.

The prediction environment 200 may be configured to receive input features 201. The input features 201 may include historical game data and/or in-game data. The input features 201 may include data relating to a game (e.g., historical game data), the players, external features (e.g., weather conditions), etc. The input features 201 may also include in-game features of a game being played, such as current score, current statistics, injuries, play/drive data, etc. The prediction environment 200 may receive input features 201 as input through data store 118, client device 108, the tracking system 102, or through an external server through network 105. Input features 201 may include or may be extracted from tracking data and/or event data. Tracking data may be based on a broadcast or in-venue feed. Event data may be system or human annotated data (e.g., based on a broadcast or in-venue feed).

The initial modules 202 may include a play probability module 210, a drive score probability module 212, and a drive remaining module 214. The play probability module 210 may be configured to predict the outcome of each play during the course of a game. This may include the predicted play as well as the predicted outcome of the play. The play probability module 210 may include a random forest classifier. The random forest classifier of the play probability module 210, may have, for example, approximately 150 trees, a max depth of approximately 14, a minimum samples leaf of approximately 4, a minimum sample split of approximately 10, where the bootstrap is set to false.

The play probability module 210 may be configured to receive input features such as the pre-game statistical odds, the pre-game predicted score and score differential. The input features may further include in-game data such as: time-left in a half, current score total and score differential, what sporting down (e.g., first down, second down, third down, or fourth down in a football game), timeouts left for each team, and team in possession of the ball. The play probability module 210 may be configured to predict a particular play outcome. The particular play outcome may include, but isn't limited to, a score (e.g., field goal) made, an attempted score (e.g., field goal) missed, an in-game action (e.g., a first down), no action (e.g., an incomplete pass or a rush or pass play that gain less yards than a first down), an offensive score (e.g., a touchdown), a possession change (e.g., a punt), or a turnover.

In an example, the play probability module 210 may be trained on regulation plays from a scrimmage and/or from one or more previous seasons of a sporting event. Previous statistics from the NFL season may have been utilized for training data, development data, and testing data. For example, the regulation play from scrimmage data (e.g., plays that did not include a penalty) from 2008 to 2019 of the NFL season in a given league may be utilized as training data. For example, the training data may include, for example, approximately 3204 games and approximately 446,629 sample plays from these games. The 2020 through 2021 season may have been utilized for development data. The development data may have included approximately 554 games and approximately 76,484 plays. The NFL season may be utilized for testing set data.

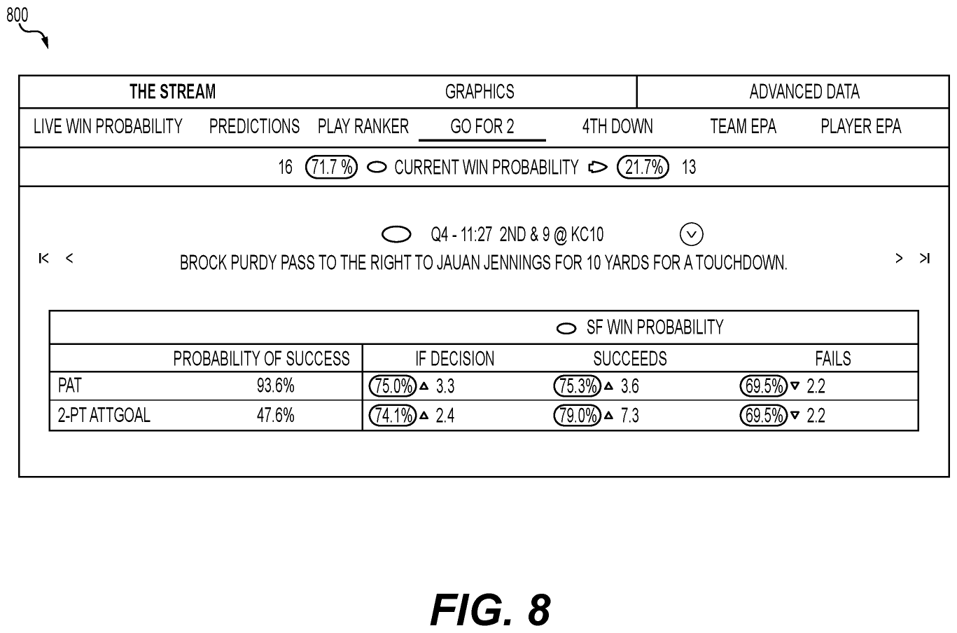

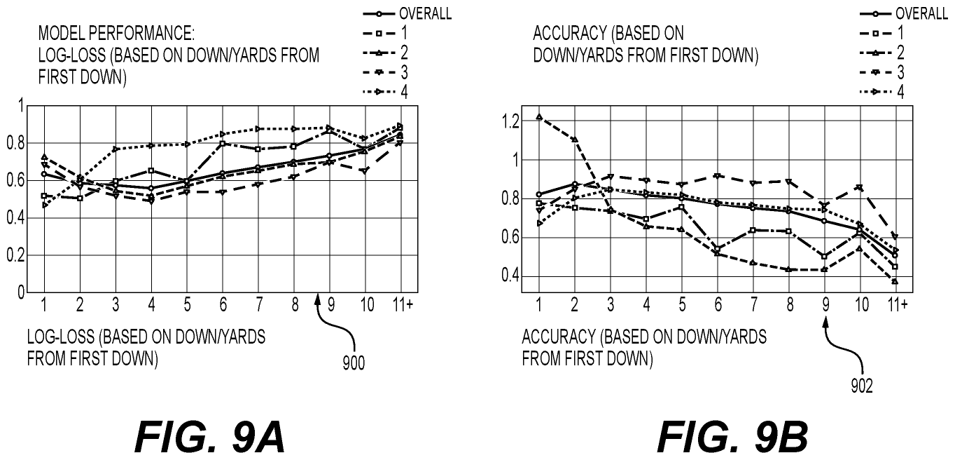

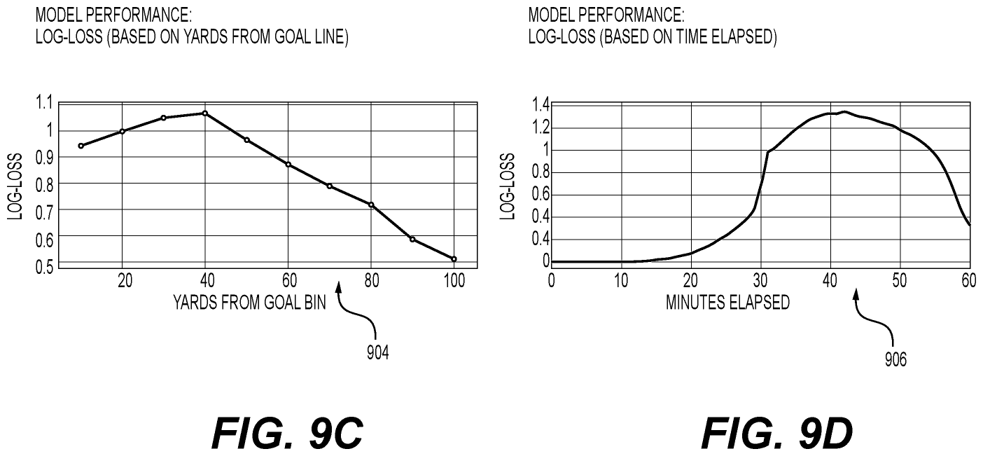

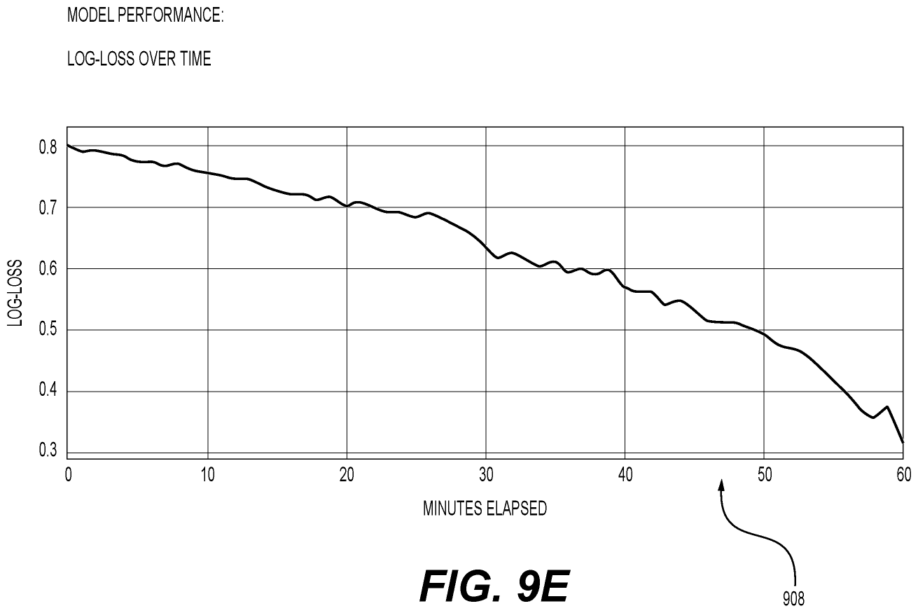

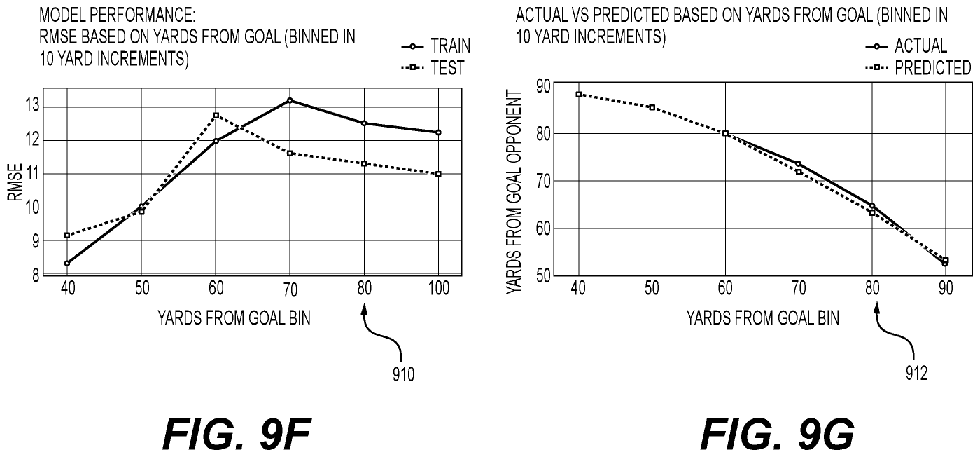

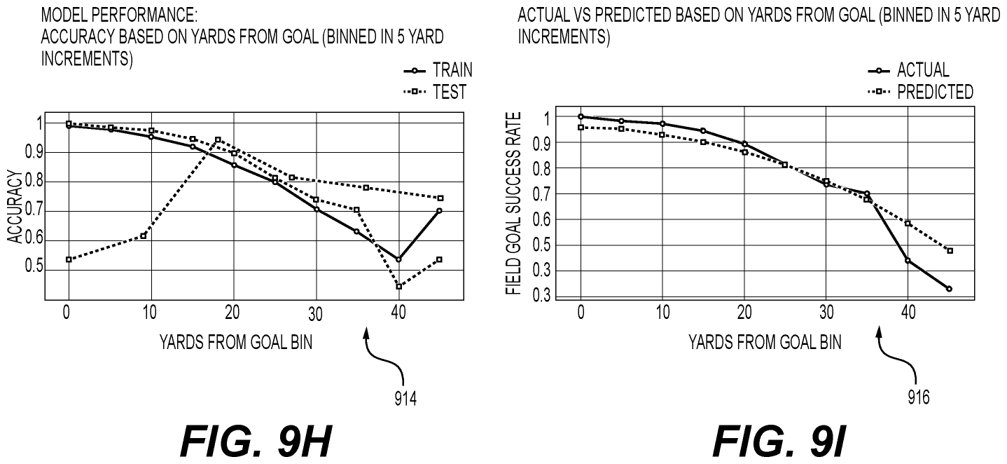

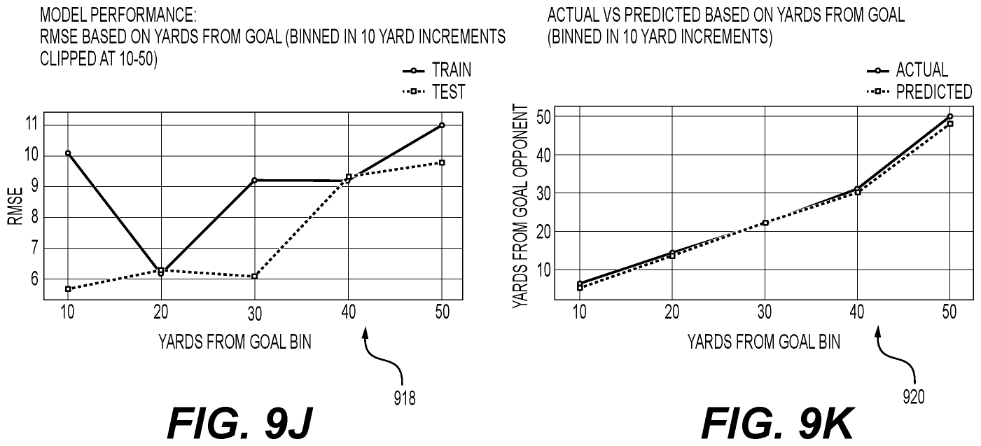

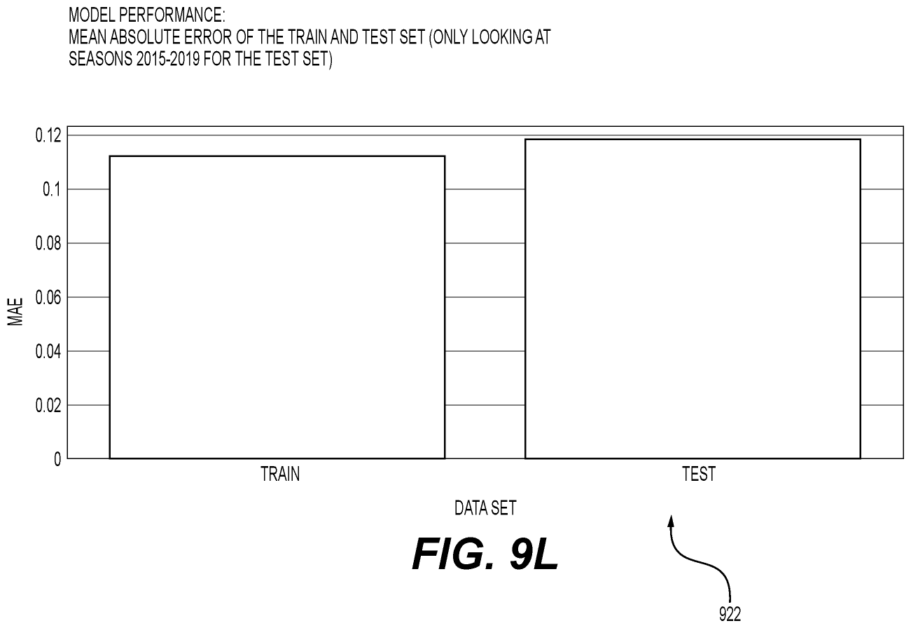

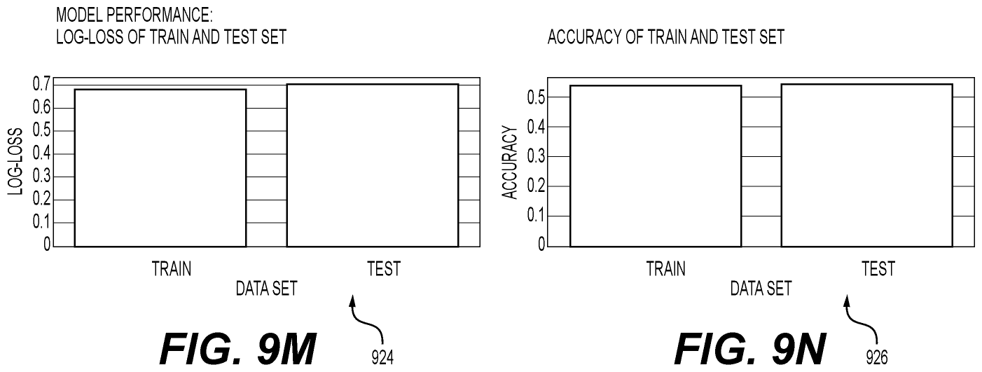

As an example, FIG. 9A-9B is an exemplary output of model performance of a play probability module 210, according to one or more embodiments. A graph 900 may depict the log-loss of the model based on the down/yards from first down, for all four potential downs of a football play. A graph 902 may depict the accuracy based on down/yards from first down for the play probability module 210.

The initial modules 202 may further include a drive score probability module 212. The drive score probability module 212 may be configured to predict the outcome of a particular drive in a game. For example, the drive score probability module 212 may predict whether the particular team with possession of the ball scores either 0, 2, 3, 6, 7, 8 points. The drive score probability module 212 may include a multi-layer perceptron model. For example, the multi-layer perceptron model may have the following specifications: an activation of relu; an Alpha of approximately 0.0001; hidden layer sizes of approximately 10, 30, 10; an early stopping set to true; and an n_iter_no_change of approximately 5.

The drive score probability module 212 may be configured to receive input features such as the pre-game statistical odds, the pre-game predicted score and score differential. This data may capture the relative team strength and relative offensive and defensive performances of each team. The input features may further include in-game data such as: time data, score data, in-game even data, time out data, possession data, etc. such as time-left in a half, current score total and score differential, what sporting down (e.g., first down, second down, third down, or fourth down in a football game), timeouts left for each team, and team in possession of the ball.

The drive score probability module 212 may determine a percentage chance of each score occurring by the end of a particular drive. The potential scores may be 0, 2 3, 6, 7, or 8, for example. A score of 0 may occur if the team doesn't score. This may occur from the offensive team punting the football or turning over the ball (e.g., by throwing an interception, fumbling the football, or not converting a fourth-down attempt). A score of three may occur if the offensive team makes a field goal. A score of six may occur if a team scores a touchdown and then fails to convert the extra point. A score of seven may occur if a team scores a touchdown then kick an extra point of a field goal. A score of eight may occur if a team scores a touchdown and successfully converts a two-point conversion. The drive score probability module 212 may be configured to determine a percentage chance that each of the potential scores occurs prior to each play in a game.

In an example, the drive score probability module 212 may be trained on regulation plays from scrimmage from one or more previous seasons of a sporting event. Previous statistics from the league's season may be utilized for training data, development data, and testing data. For example, the regulation play from scrimmage data (e.g., plays that did not include a penalty) from 2008 to 2019 of an NFL season may have been utilized as training data. The training data may include approximately 3204 games and approximately 446,629 sample plays from these games. The 2020 through 2021 NFL season may have been utilized for development data. The development data may have included approximately 554 games and approximately 76,484 plays. The 2022 NFL season may have been utilized for testing set data.

As an example, FIG. 9C is an exemplary output of model performance of a drive score probability module 212, according to one or more embodiments. Graph 904 may include the log-loss performance of the model based on yards from the opponent's goal line.

The initial modules 202 may include a drive remaining module 214. The drive remaining module 214 may be configured to predict how many drives each team in a sporting event will have remaining in the game. The drive remaining module 214 may include a multi-layer perceptron model. For example, the multi-layer perceptron model may have the following specifications: an activation of relu; an Alpha of approximately 0.0001; hidden layer sizes of approximately 50, 50, 50; an early stopping set to true; and an n_iter_no_change of approximately 5.

The drive remaining module 214 may be configured to receive input features such as the pre-game statistical odds, the pre-game predicted score and score differential. The input features may further include in-game data such as: time-left in a half, current score total and score differential, what sporting down (e.g., first down, second down, third down, or fourth down in a football game), timeouts left for each team, team in possession of the ball, and metadata on which team begins the second-half of the sporting event with the ball.

The drive remaining module 214 may output a whole number of the remaining number of drives predicted for each team of the sporting event. In an example, the drive remaining module 214 may have been trained on regulation plays from scrimmage from one or more previous seasons of a sporting event. Previous statistics from the NFL season may have been utilized for training data, development data, and testing data. For example, the regulation play from scrimmage data (e.g., plays that did not include a penalty) from 2008 to 2019 of the NFL season may have been utilized as training data. The training data may include approximately 3204 games and approximately 46,629 sample plays from these games. The 2020 through 2021 NFL season may have been utilized for development data. The development data may have included approximately 554 games and approximately 76,484 plays. The 2022 NFL season may have been utilized for testing set data.

For example, FIG. 9D is an exemplary output of model performance of a drive remaining module 214, according to one or more embodiments. Graph 906 may depict the log-loss based on time elapsed throughout the sporting event.

All outputs determined by the initial modules 202 may be saved to the data store 118 and may be utilized by other models in the prediction environment 200. The prediction environment 200 may include an EPA module 204. The EPA module 204 may receive as input the outputs from the drive score probability module 212. The EPA module 204 may utilize the received drive prediction to calculate an expected number of points that will be scored on a particular drive in a sporting event. The EPA module 204 may further receive the pre-game statistical odds, the pre-game predicted score and score differential. The EPA module 204 may further receive the in-game data such as time-left in a half, current score total and score differential, what sporting down (e.g., first down, second down, third down, or fourth down in a football game), the field position, and team in possession of the ball.

In use, the EPA module 204 may set any pre-game statistic odds to a league statistical average. For example, a predicted point differential between the two teams may be set to zero and the total predicted score may be set to 45 points. These may be the average predicted point differential and average predicted total score for a football game. The EPA module 204 may, using the predicted probability of each drive result and number of points associated with the drive result, calculated an expected points total for a particular drive. As plays occur and in-game data is received, the EPA module 204 may update the outcome of drives live in a game. An example of received data from the drive score probability module 212 may be depicted in Table 1 below:

TABLE 1

| Drive Result | Touchdown | Field Goal | Safety | Other |
|---|---|---|---|---|
| Probability | 0.15 | 0.22 | 0.03 | 0.60 |

The predicted expected points in this scenario of chart 1 would be: 0.15*6+0.22*3−2*0.03+0*0.60=1.5 points. The EPA module 204 may be configured to predict the difference in expected points from one play to the next in the game. The EPA module 204 may aggregate this action by player and by team over a game and over the season. An EPA may be assigned to a skill position player such as a quarterback, a tight end, a receiver, or a running back. Further, a quarterback's EPA may not be effected when handing off the ball on a running play.

In an example scenario, a football game may occur between team A and team B. At this time, the in-game data may indicate that there may be 21 seconds remaining in the third quarter, that team A is down by 3 points to team B. Team A may have player C rush the ball for two yards to team B's 42 yard line. After the rushing player, Team A may have a first down and 10 yards to go with the ball at the team B's 42 yard line. The EPA module 204 may determine that the current Expected points for team B on the drive may be calculated to be 2.79 after this play.

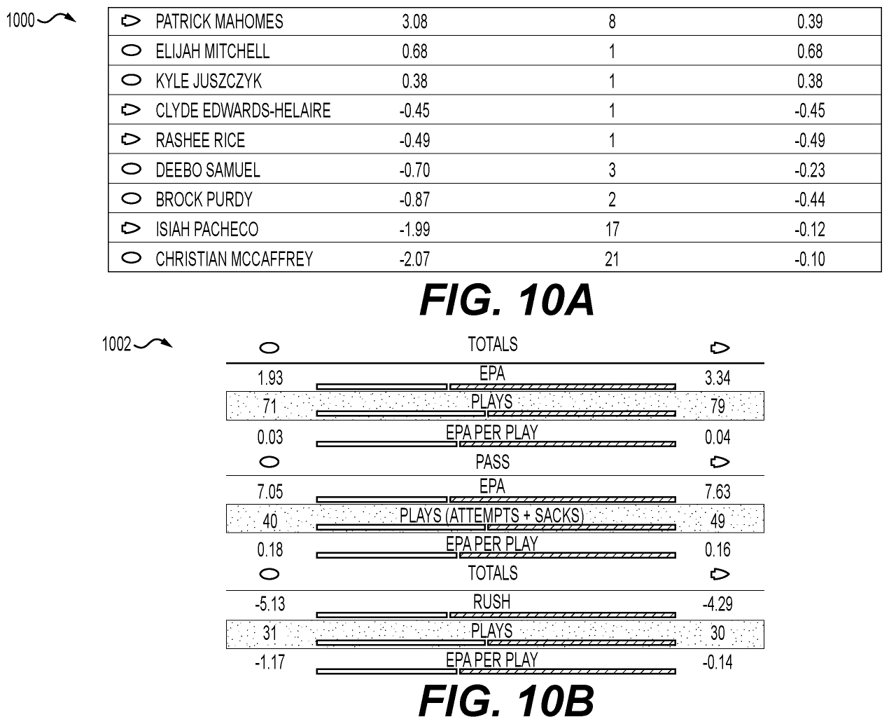

On the next play, the in-game data my indicate that there are 15 minutes remaining in the fourth quarter, that team A is down by 3 points to team B, Team A has a first down and 10 yards to go with the ball at team B's 11 yard line. Team A may have player D may pass the ball twenty yards to player E to the team B's 22 yard line. The expected points may be determined to be 3.92 points. The difference in points added may be 3.92−2.79=1.13 points added. Thus, players D and E may be credited with 1.13 EPA. FIG. 10A-10B are exemplary outputs of the EPA module 204, according to one or more embodiments. FIG. 10A depicts graph 1000 of the predicted EPA per player in an exemplary game. FIG. 10B depicts graph 1002 of the predicted EPA per team in an exemplary game. For graph 1000, the left most column may refer to players in a game with an assigned EPA, the next column to the right may be the total EPA for the players for a particular season, the next column to the right may be the number of touchdowns the player contributed (e.g., caught, threw, or rushed), and the last far right column may refer to the ratio of EPA/play.

The prediction environment 200 may include a LWP module 206. The LWP module 206 may be configured to determine a probability of each team winning for each team in a live sporting event. The LWP module 206 may specify each possession change for each team, a win probability for each team, and a chance of overtime as the game progresses. The LWP module 206 may include a multi-layer perceptron model. The multi-layer perceptron model may have the following specifications, for example: an activation of relu; an Alpha of approximately 0.05; hidden layer sizes of approximately 50, 50; an early stopping set to true; and an n_iter_no_change of approximately 5.

The LWP module 206 may be configured to receive as input features such as the pre-game statistical odds, the pre-game predicted score and score differential. The input features may further include in-game data such as: time-left in a half, current score total and score differential, timeout's left for each team, and team in possession of the ball, and binary values for points after and kickoff (e.g., where or not a play is a kickoff or a PAT attempt). The LWP module 206 may further receive predicted data from the initial modules 202. For example, the LWP module 206 may receive the offensive drive score probability and the remaining drive predictions from the drive score probability module 212 and the drive remaining module 214 respectively. The LWP module 206 may be configured to determine a live game winning percentage per team in the sporting event.

In an example, the LWP module 206 may have been trained on regulation plays from scrimmage from one or more previous seasons of a sporting event. Previous statistics from the NFL season may have been utilized for training data, development data, and testing data. For example, the regulation play from scrimmage data (e.g., plays that did not include a penalty) from 2008 to 2019 of the NFL season may have been utilized as training data. The training data may include 3204 games. The 2020 through 2021 NFL season may have been utilized for development data. The development data may have included 554 games. The 2022 NFL season may have been utilized for testing set data.

FIG. 9E is an exemplary output of LWP module 206, according to one or more embodiments. Graph 908 may depict the log-loss over time of the LWP module 206 of the model prediction throughout a sixty minute sporting event.

The prediction environment 200 may include additional modules 203. The additional module 203 may be depicted in FIG. 2B. The additional modules 203 may include a punt field position module 220, a field goal success probability module 222, a go-for-it success next yard modules 224, and a point-after kick success probability module 226, and a two-point conversion module 228. The modules within the additional modules 203 may be located within the computing system 104. Further, one or more of the modules may be located on an external server accessed through network 105.

The additional modules 203 may include a punt field position module 220. The punt field position module 220 may be configured to predict the field position of a team receiving a punt. The punt field position module 220 may include a multi-layer perception repressor model. The multi-layer perceptron regressor model may have the following specification: an activation of relu; an Alpha of approximately 0.0001; hidden layer sizes of approximately 100; and an n_iter_no_change of approximately 5. In another example, the punt field position module 220 may utilize linear regression techniques instead of a multi-layer perceptron regressor.

The punt field position module 220 may be configured to receive input features such as the pre-game statistical odds, the pre-game predicted score and score differential. The pre-game statistical odds may include the punters average yards per punt. The input features may further include in-game data such as: time-left in a half, current score total and score differential, yards away from opposing team's end zone, and team in possession of the ball. The punt field position module 220 may predict the field position of the receiving team after a punt. The punt field position module 220 may determine a predicted number of yards that the receiving team is from the opponent's end zone.

In an example, the punt field position module 220 may have been trained on regulation plays from scrimmage from one or more previous seasons of a sporting event. Previous statistics from the NFL season may have been utilized for training data, development data, and testing data. For example, the regulation play from scrimmage data (e.g., plays that did not include a penalty) from 2008 to 2019 of the NFL season may have been utilized as training data. The training data may include approximately 3204 games and approximately 29,824 sample plays from these games. The 2020 through 2021 NFL season may have been utilized for development data. The development data may have included approximately 554 games and approximately 4,179 plays. The 2022 NFL season may have been utilized for testing set data.

FIG. 9F-9G are exemplary outputs of model performance of a punt field position module 220, according to one or more embodiments. Graph 910 depicts the model performance of root-mean-square deviation (RMSR) of the model based on yards from the goal (where the graph 910 depicts the results as binned in 10 yard increments). Graph 912 depicts the actual vs predicted yards from goal (binned in 10 yard increments) as applied to the test data.

The additional modules 203 may include a field goal success probability module 222. The field goal success probability module 222 may be configured to predict the probability of a successful field goal when a team attempts a field goal. The field goal success probability module 222 may include a multi-layer perceptron classifier. The multi-layer perceptron classifier model may have the following specifications: an activation of relu; an Alpha of approximately 0.0001; hidden layer size of approximately 100; and an n_iter_no_change of approximately 5.

The field goal success probability module 222 may be configured to receive input features such as the pre-game statistical odds, the pre-game predicted score and score differential. The pre-game statistical odds may include each kicker in a game's historical field percentage and statistics. The pre-game statistical odds may include the historical field goal percentage of each teams kicker. The input features may further include in game data such as: current score total and score differential, field position (e.g., yards from the end zone), and team in possession.

In an example, field goal success probability module 222 may be trained on regulation plays from scrimmage from one or more previous seasons of a sporting event. Previous statistics from the NFL season may have been utilized for training data, development data, and testing data. For example, the regulation play from scrimmage data (e.g., plays that did not include a penalty) from 2008 to 2019 of the NFL season may have been utilized as training data. The training data may include approximately 3204 games and approximately 12,326 sample plays from these games. The 2020 through 2021 NFL season be utilized for development data. The development data may have included approximately 554 games and approximately 2,091 plays. The 2022 NFL season may have been utilized for testing set data.

FIG. 9H-9I are exemplary outputs of model performance of field goal success probability module 222, according to one or more embodiments. Graph 914 may depict the model performance of the accuracy based on yards from the goal (wherein the results are binned in five yard increments). Graph 916 may depict the actual vs predicted results based on yards from a field, as determined for the test set data.

The additional modules 203 may include a go-for-it success next yards module 224. The go-for-it success next yards module 224 may be configured to predict that if a team goes for a fourth down attempt, which their field position (e.g., yards from the goal) will be on the following play given that they are successful in their attempt. The go-for-it success next yards module 224 may include a multi-layer perceptron classifier model. The multi-layer perceptron model may have the following specifications: an activation of relu; an Alpha of approximately 0.0001; hidden layer size of approximately 100; and an n_iter_no_change of approximately 5. In another example, the model may utilize linear regression rather than a multi-layer perception classifier.

The go-for-it success next yards module 224 may be configured to receive input features such as the pre-game statistical odds, the pre-game predicted score and score differential. The input features may further include in-game data such as: time-left in a half, current score total and score differential, yards from the goal, yards to a first down, and team in possession of the ball.

In an example, go-for-it success next yards module 224 may have been trained on regulation plays from scrimmage from one or more previous seasons of a sporting event. Previous statistics from the NFL season may have been utilized for training data, development data, and testing data. For example, the regulation play from scrimmage data (e.g., plays that did not include a penalty) from 2008 to 2019 of the NFL season may have been utilized as training data. The training data may include approximately 3204 games and approximately 25,015 sample plays from these games. Sample plays may refer to fourth down plays in regulation where an offense successfully converted a first down and the play counted (e.g., there were no penalties reversing the first down). The 2020 through 2021 NFL season may have been utilized for development data. The development data may have included approximately 554 games and approximately 678 plays. The 2022 NFL season may have been utilized for testing set data.

FIG. 9J-9K is an exemplary output of model performance of a go-for-it success next yard module 224, according to one or more embodiments. Graph 918 depicts the model performance of RMSR based on yards from goal (binned in 10 yard increments and clipped to 10 to 50 yard gains). Graph 920 depicts the actual vs predicted output based on yards from goal (binned in ten yard increments).

The additional modules 203 may include a point-after kick success probability module 226. The point-after kick success probability module 226 may be configured to predict the probability of a successful extra point kick attempt when a team attempts an extra point kick. The point-after kick success probability module 226 may apply logistic regression techniques. For example, the logistic regression techniques may have the following specifications: C=0.616 (C may refer to the hyper parameter that controls the strength of regularization penalty), penalty=L1 (e.g., the coefficient values of the model are penalized), and the solver=liblinear.

The point-after kick success probability module 226 may be configured to receive input features such as the pre-game statistical odds, the pre-game predicted score and score differential. The input features may further include in-game data such as: current score total and score differential, yards from the goal, and team in possession of the ball.

The point-after kick success probability module 226 may be trained on regulation plays from scrimmage from one or more previous seasons of a sporting event. Previous statistics from the NFL season may be utilized for training data, development data, and testing data. For example, the regulation extra point attempts from scrimmage data (e.g., plays that did not include a penalty) from 2008 to 2019 of the NFL season may have been utilized as training data. The training data may include approximately 3204 games and approximately 15,161 sample plays from these games. The 2020 through 2021 NFL season may have been utilized for development data. The development data may have included approximately 554 games and approximately 2,716 plays. The 2022 NFL season may have been utilized for testing set data.

FIG. 9L is an exemplary output of model performance of an extra point kick success model, according to one or more embodiments. Graph 922 depicts the model performance of the mean absolute error of the training and test set data.

The additional module 203 may include a two-point conversion module 228. The two-point conversion module 228 may be configured to determine a two-point conversion success rate. The two-point conversion module 228 may include a multi-layer perceptron classifier. The multi-layer perceptron model may have the following specifications: an activation of tanh; an Alpha of approximately 0.05; hidden layer sizes of approximately 50, 50, 50; and an n_iter_no_change of approximately 5.

The two-point conversion module 228 may be configured to receive input features such as the pre-game statistical odds, the pre-game predicted score and score differential. The input features may further include in-game data such as: current score total and score differential and the team in possession.

In an example, the two-point conversion module 228 may be trained on regulation two-point conversions from one or more previous seasons of a sporting event. Previous statistics from the NFL season may be utilized for training data, development data, and testing data. For example, the regulation play from scrimmage data (e.g., plays that did not include a penalty) from 2008 to 2019 of the NFL season may have been utilized as training data. The training data may include approximately 3204 games and approximately 1,002 sample plays from these games. The 2020 through 2021 NFL season may have been utilized for development data. The development data may have included approximately 554 games and approximately 303 plays. The 2022 NFL season may have been utilized for testing set data.

FIG. 9M-9N is an exemplary output of model performance of a two-point conversion module 228, according to one or more embodiments. Graph 924 may depict the model performance of log-loss of the training data and the test set. Graph 926 may depict the model performance of accuracy of the train and test sets of data.

The prediction environment 200 may include decision modules 208. The decision modules 208 may be configured to determine a probability of success for various actions in a specific play scenario in a sporting event. The decision modules 208 may be configured to receive input features 201 as well as one or more outputs from the initial modules 202, additional modules 203, and from the live win probability module 206.

The prediction environment 200 may include a fourth down predictor 216 and two-point predictor 218. The fourth down predictor 216 may be configured to predict a likelihood of an action being taken on 4th down (e.g., go for it, punt, kick a field goal), a probability of success for each action, and/or a win percentage if either action is taken. The go-for-two predictor 218 may be configured to predict a likelihood of an action being taken after a touchdown (e.g., going for two or kicking an extra point), a probability of success for each action, and/or a win percentage if either action is taken. The fourth down predictor 216 may receive as inputs the outputs of the following modules: the punt field position module 220, the field goal success probability module 222, the to-for-it success next yards module 224, the play probability module 210, the drive score probability module 212, and the LWP module 206.

The fourth down predictor 216 may be configured to receive the expected win probability of the offense for the following decision: 1) a successful or failed fourth down attempt, 2) a successful or failed field, goal, and 3) a punt. These probability may for example be received by the go-for-it success next yards module 224, the field goal success probability module 222. An exemplary output for the fourth down predictor 216 is depicted in Table 2 below.

TABLE 2

| | | Success | Win % if | |
|---|---|---|---|---|
| Decision | Win % | % | Fail | Win % if Success |
| Go For it | 62.2% | 22.8% | 55.0% | 86.8% |
| Field Goal | 55.9% | 1.6% | 55.4% | 86.5% |
| Attempt | | | | |
| Punt | 69.1% | | | |

The far left column (e.g., the first column) depicts the potential decisions the fourth down predictor 216 may output. The next column (e.g., the second column) depicts the win probability of the offensive team based on performing the particular decision. The next column (e.g., the third column) depicts the probability that the offensive team will succeed if the particular decision is performed. The next column (e.g., the fourth column), is the predicted win probability of the offensive if the team fails at the play attempt. The next column (e.g., the fifth column), is the predicted win probability if the offensive team successfully performs the play. The fourth down predictor 216 may utilize the following formula to predict the win % for each decision:

$$Win \% = “ Win \% if Success ” * “ Success \% ” + ( 1 - “ Success \% ” ) * “ Win \% if Fail ”$$

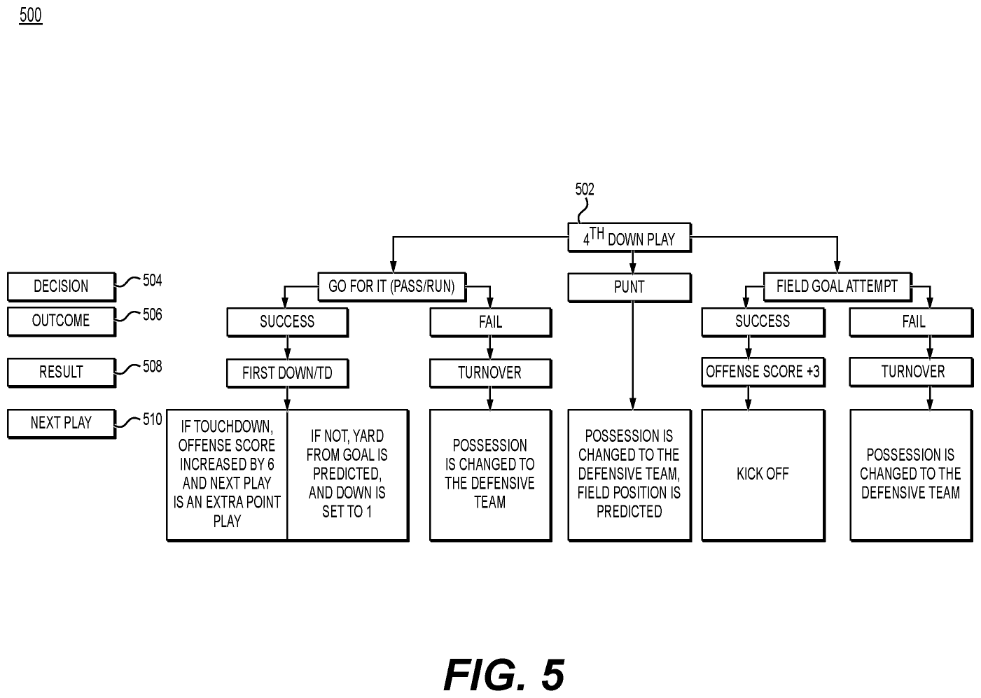

FIG. 5 is a flow diagram 500 of an exemplary fourth down predictor 216, according to one or more embodiments. Flow diagram 500 depicts the exemplary decisions 504 that a team can perform and that the fourth down predictor 216 may suggested on a fourth down play 502 in a football game. As will be discussed further, the fourth down predictor 216 may provide a probability of success for each of the decisions 504. The fourth down predictor 216 may further output a predicted win percentage based on a team performing a particular decision. The three options may be an attempted first down (e.g., by a rushing or passing play), punting the football to the opposing team, or attempting the field goal. The potential outcomes 506 of this scenario may be as follows. If a team attempts a first down, they may either be successful or fail. If punting, the team will willingly give possession to the other team. If a field goal is attempted, the team may be either successful or fail. The results 508 of this scenario are for a successful first down attempt, a team will have either scored a touchdown or converted a first down. The result 508 for a failed first down attempt is a turnover on downs (e.g., the offensive team turns over the ball to the other team and becomes the defensive team). The results of a punt are that possession has changed to other team along with field position (e.g., based on how far the ball was punted). The result 508 of a successful field goal attempt is three points for the offensive team. The result 508 of a failed field goal attempt is a turnover on downs. The fourth down predictor 216 may further take into account the next play 510. The next play 510 if a first down or touchdown is scored may either be: a) if a touchdown is scored, the offensive team may perform an extra point play while increasing the offensive team's score by six, or b) if a first down is achieved, but not a touchdown, then the offense may receive a new set of downs. If a failed first down attempt occurs, the next play 510 may be possession is changed to the defensive team and they have a new set of down. If a punt occurs, the next play 510 may be that possession is changed to the defensive team. If a successful field goal occurs, the next play 510 may be a kickoff to the defensive team. If a field goal occurs, the next play 510 may be a change of possession to the defensive team.

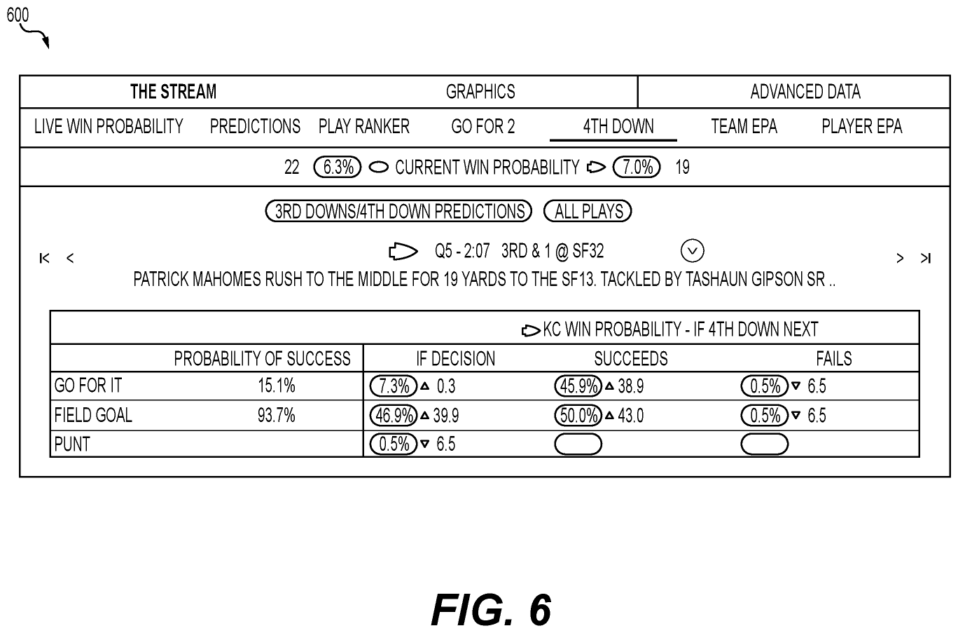

FIG. 6 is an exemplary output 600 of a fourth down predictor 216, according to one or more embodiments. As depicted in the output 600, the potential fourth down options of “go for it” (e.g., a first down attempt), a field goal, and a punt are listed. The fourth down predictor 216 further indicates the probability of success and the indication of the win probability if each play was to either succeed or fail.

The two-point predictor 218 may determine the expected win probability for a successful and failed two point conversion along with a successful and failed extra point attempt. The two-point predictor 218 may receive—as inputs the outputs of the following modules: the point-after kick success probability modules 226, the two point conversion modules 228, and the LWP module 206. An exemplary output from the two-point predictor 218 is depicted in table 3 below.

TABLE 3

| | | Success | Win % if | Win % if |
|---|---|---|---|---|
| Decision | Win % | % | Fail | Success |
| Go For Two | 28.8% | 52.7% | 9.8% | 45.9% |
| Kick XP | 10.0% | 93.7% | 9.8% | 10.0% |

The far left column (e.g., the first column) depicts the potential decisions the two-point predictor 218 may output. The next column (e.g., the second column), depicts the win probability of the offensive team based on performing the particular decision. The next column (e.g., the third column) depicts the probability that the offensive team will succeed if the particular decision is performed. The next column (e.g., the fourth column) is the predicted win probability of the offensive if the team fails at the play attempt. The next column (e.g., the fifth column), is the predicted win probability if the offensive team successfully performs the play. The two-point predictor 218 may utilize the following formula to predict the win % for each decision: Win %=“Win % if Success”*“Success %”+(1−“Success %”)*“Win % if Fail”.

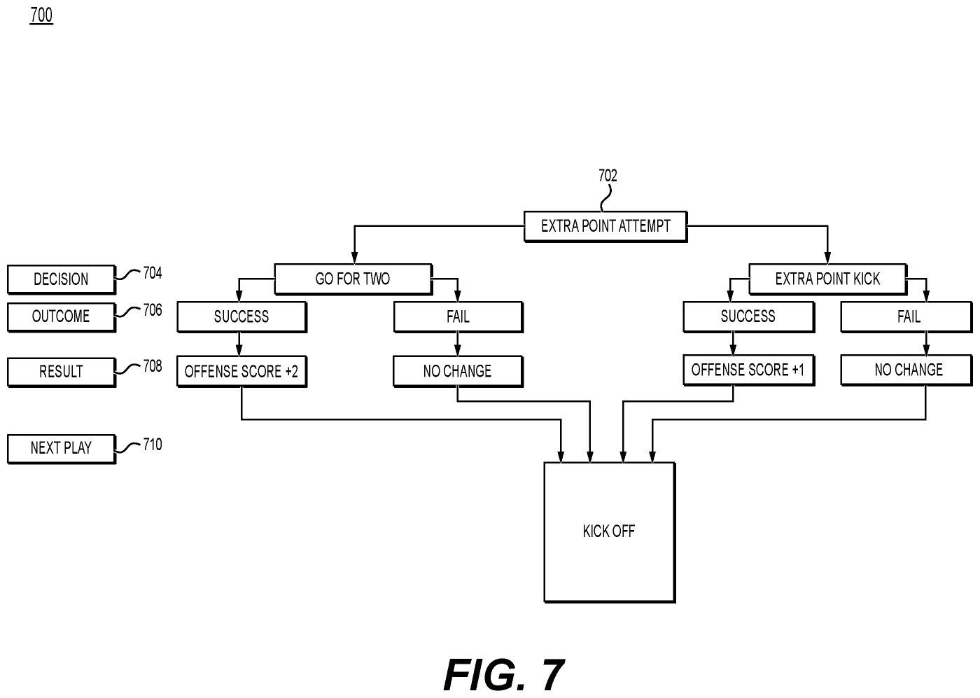

FIG. 7 is a flow diagram 700 of an exemplary two-point predictor 218, according to one or more embodiments. Flow diagram 700 depicts the exemplary decisions 704 that a team can perform and that the two-point predictor 218 may suggest on a two point conversion 702 in a football game. The two-point predictor 218 may provide a probability for success of each of the decisions 704. The two-point predictor 218 may further output a predicted win percentage based on a team performing a particular decision. The two decisions 704 may be to either “go for two” which includes attempting a run of pass play to score two points or an extra point kick to score a single point. A potential outcomes 706 for the “go for two” is either success, where the result 708 is 2 points for the offense or failure where the result is no change to score and the defensive team will proceed with receiving a kickoff. The potential outcome 706 for the extra point is either success where the result 708 is the offensive team obtain 2 points or failure where there is no change to the score and the defensive team with proceed with receiving a kickoff. Regardless of the results, the next play 710 may be a kickoff from the previously offensive team to the defensive team.

FIG. 8 is an exemplary output 800 of the two-point predictor 218, according to one or more embodiments. As depicted in the output 800, the potential plays (e.g., extra point attempt or two point attempt) are listed along with their determined probability of success and the indication of the win if each play was either to succeed or fail.

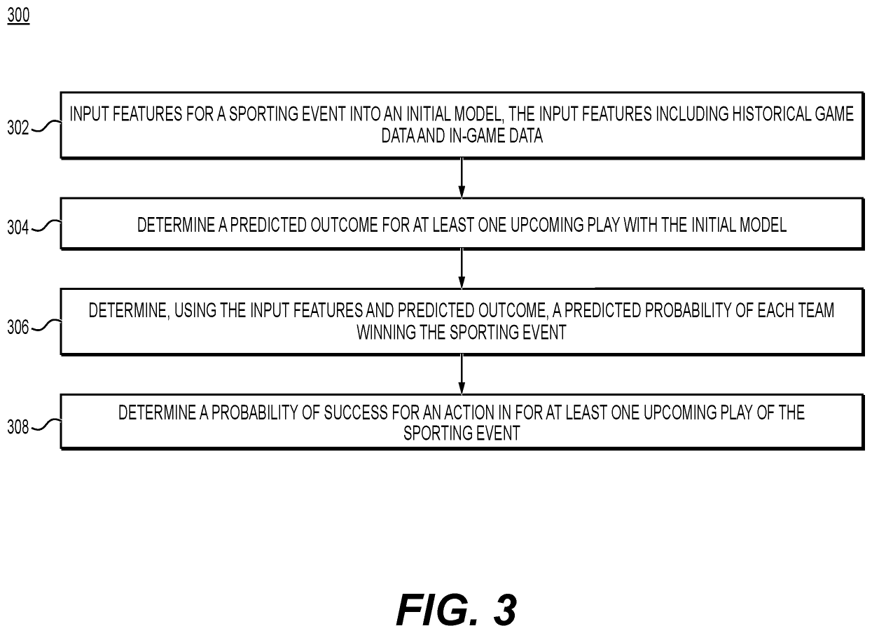

FIG. 3 is a flow diagram of an exemplary method 300 for determining a probability of success for an action in a specific play of a sporting event, according to one or more embodiments. The method 300 may be implemented by the prediction environment 200.

At step 302, the system may receive input features (e.g., from input features 201) for a sporting event for application with an initial model (e.g., initial modules 202). The input features may include historical game data and in-game data. The in-game data may include any of a time left for a remaining portion of the sporting event, a current point total, a current point differential, a current down and distance to go to a first down, a number of timeouts remaining, a team in possession, yards from goal, and position on field. The historical data may include a repository of historical team and player data for one or more sporting events. This may include pre-game statistical odds of which team is favored to win, pre-game predicted score totals and point differentials. Historical team data may include for example, all of the team's wins and losses vs respective opponents, the total goals on the year, the total assists on the year, the record vs respective teams over a period of time, the date of all games, the attendance per game, whether particular games are home/away, etc. Historical player data may include rush yards, rush yard per game, rush yards per carry, rushing touchdowns, fumbles, receiving yards, receiving yards per game, receiving yards per catch, pass yards, receiving touchdowns, pass yards per game, pass yards per attempt, pass touch downs, pass interceptions, field goals made and attempted at particular distances, and extra-point field goal statistics.

The input models may include a play probability model, the play probability model being configured to predict a probability of a particular play outcome occurring in the sporting event; a drive score probability model, the drive score probability model being configured to generate a probability of a particular score outcome occurring on a drive in the sporting event; and a drive remaining model, the drive remaining model being configured to predict the number of remaining drives for each team in the sporting event. The play probability model may include a random forest classifier, the drive score probability model may a multi-layer perceptron, and the drive remaining model may includes a multi-layer perceptron.

The system may further receive input features into addition modules (e.g., additional modules 203). The additional models may include: (1) a punt field position model, the punt field position model being configured to predict the field position of a receiving team after a punt; (2) a field goal success probability model, the field goal success probability model being configured to predict the probability of a successful field goal when a team attempts a field goal; (3) a go-for-it success next yards model, the model being configured to predict if a team attempts a fourth down play, what field position will the team end up with after the given play, assuming the team successfully converts the fourth down; (4) a point after kick success probability model, the model being configured to predict the probability of a successful extra point kick attempt; and (5) the two-point success probability model, the model being configured to predict the probability of a successful two point conversion when attempted.

At step 304, the system may determine a predicted outcome with the initial model. The predicted outcome may include the probability of the particular play outcome occurring in the sporting event, the probability of the particular score outcome occurring on the drive in the sporting event, and/or the predicted number of remaining drives for each team in the sporting event.

The predicted outcome for the particular play may include each of a set of play outcomes and a corresponding probability of each of the set of play outcomes being performed based on a current down and yardage from a first down. The predicted outcome for the particular play may include each of a set of drive outcomes and a corresponding probability of each of the set of drive outcomes based on a number of yards from a goal line.

The predicted outcome may further include: a predicted field position of a receiving team after a punt; a predicted probability of a successful field goal when a team attempts a field goal; a predicted field position for a team after successfully converting a fourth down attempt; a predicted probability of a successful extra point kick attempt; and a predicted probability of a successful two point conversion when attempted.

At step 306, the system may determine, using the input features and predicted outcome, a probability of each team winning the sporting event. The probability of each time winning the sporting event may be determined by a live win probability model. The live win probability model may include a multi-layer perceptron, the live win probability model receiving the outputs from the drive score probability model and drive remaining model.

At step 308, the system may determine a probability of success for an action in a specific play of the sporting event. The sporting event may be an American football game or any other sporting event, as discussed herein. In an American football example, the action in the specific play may be a two-point conversion in the American football game. The probability of success for the two-point conversion may be determined by a two-point predictor. The two-point predictor may include the steps of identifying each of two potential actions capable of being performed, the two potential actions comprising performing an extra point kick and performing an offensive play after scoring of a touchdown; deriving a success rate of each potential action using the predicted outcome for the at least one upcoming play; and deriving an updated win percentage of each potential action using the predicted probability of each team winning, wherein the success rate and the updated win percentage of each potential action are used to update the predicted probability of each team winning.

The action in the specific play may be a fourth-down play in the American football game. The probability of success for the fourth-down play may be determined by a fourth down model, the fourth down model may perform the steps of: identifying each of three potential actions capable of being performed, the actions comprising performing a punt, a field goal attempt, or performing an offensive play; deriving a success rate of each potential action using the predicted outcome for the at least one upcoming play; and deriving an updated win percentage of each potential action using the predicted probability of each team winning, wherein the success rate and the updated win percentage of each potential action are used to update the predicted probability of each team winning.

The method may further include generating an expected number of points to be scored on a particular drive in the sporting event using an expected points model, the expected points model using the outcome of the drive score probability model to generated the expected number of points; and determining an expected points added per player in the sporting event.

The method may further include obtaining updated in-game data during the sporting event; and updating the predicted outcome of the sporting event.

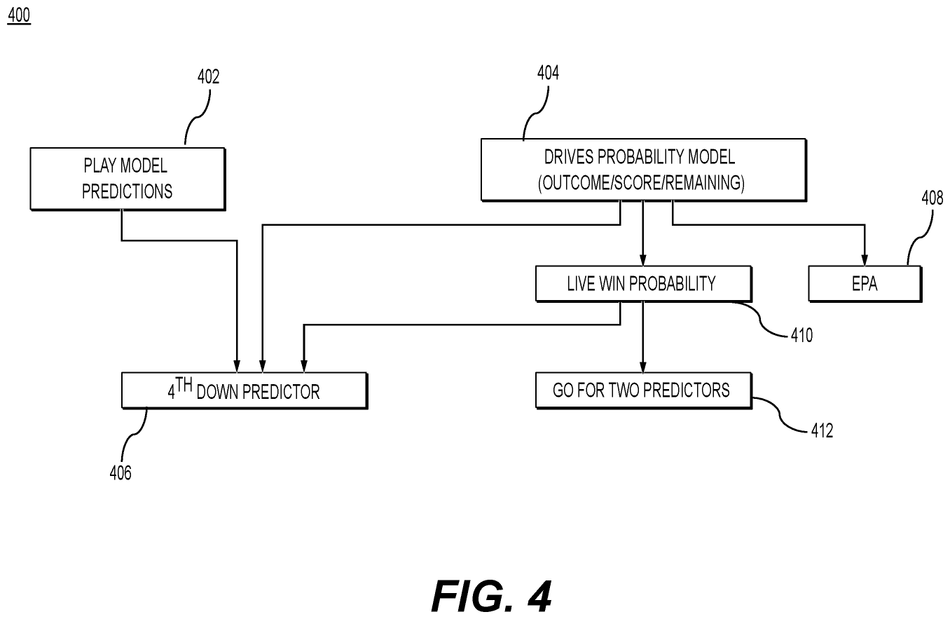

FIG. 4 is a block diagram 400 of the prediction environment 200, according to one or more embodiments. The block diagram 400 may display a simplified version of the prediction environment 200 of FIG. 2A-2B. The play model predictions 402 may correspond to the outputs of the play probability module 210. The drive probability predictions 404 may correspond to the outputs of the drive score probability module 212 and the drive remaining module 214. The drive probability predictions 402 may be fed into an EPA model 408 corresponding to the EPA module 204, into a live win probability model 410 corresponding to the LWP module 206, and to a fourth down predictor 406 corresponding to the fourth down predictor 216. The live win probability model 410 may determine in-game winning probability predictions for each team. The live win probability model 410, along with additional features, may be input into a go-for-two model 412 corresponding to the two-point predictor 218.

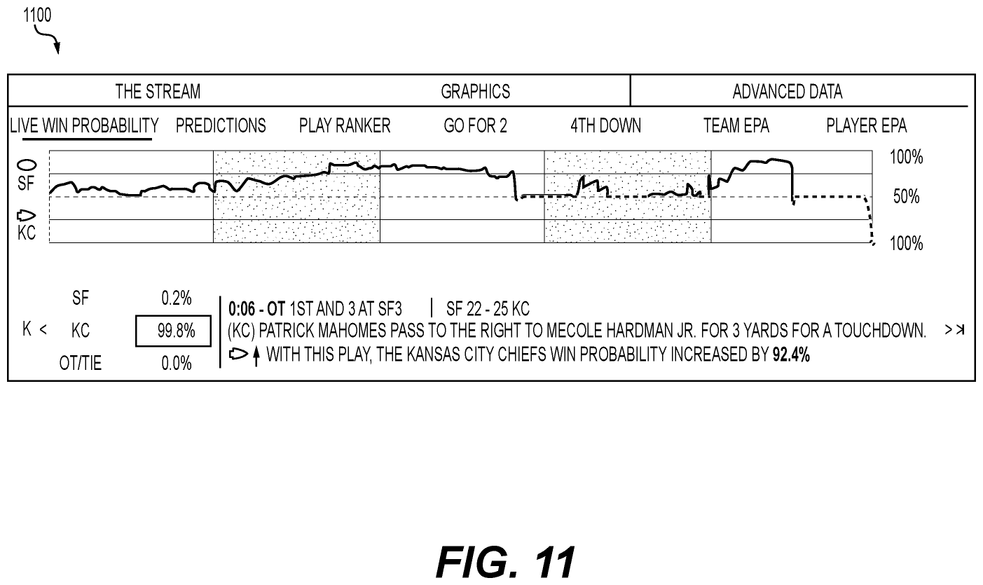

FIG. 11 is an exemplary output 1100 from the LWP module 206, according to one or more embodiments. The output 1100 depicts a graph of the updated win probability for a particular team throughout the course of an exemplary football game. As shown, a particular play such as touchdown at the end of the game, may lead to updates to the win probability.

Experimental results in accordance with the disclosed subject matter discussed below as example scenarios.

An example scenario for the fourth down predictor 216 and the prediction environment 200 may follow. In these set of examples, certain input features will remain constant. These include the half and time left in the half, the predicted score differential and favored team, and the amount of timeouts remaining for each team. The play that the example scenario includes the following input features of current in-game data: 4th Qtr 6:20, home team up by 4, score total 36, 4th & 9, 60 Yards From Goal, Home team has the ball.

In the following scenarios A-E, example next plays will be described and their corresponding effect on the models and predictions from the prediction environment. Each of these scenarios may be predicted by the go-for-it success next yard module 224. After discussion of scenarios A-E, an example of the fourth down predictor's output prior to the next play occurring is described. In the scenarios below, the home team may have the ball on offense for the fourth down attempt.

In scenario A, the predicted outcome of the fourth down play may be 4th Qtr 6:20, home team up by 4, 1st & 10, 41 Yards From Goal, Home team has the ball. A fourth down conversion may have just occurred. The yards from goal for the outcome play may be calculated using Go-For-It-Success Next Yards module 224. The module may determine that if a successful conversion occurs, the ball will move to the 41 yard line. If the result of the “go for it success next yards” is 0-1 the yards from goal is 1. If the result is less than 0, the module may consider this a touchdown and yards from goal may be set to −1. Down and yards to go may be set to first and 10 assuming the module believes a successful conversion may occur. If within 10 yards of the goal, the play may be set to first and goal. If the result was a touchdown, both values may be set to null values. Since the result of the outcome description play is not a touchdown, the score difference and total may not be changed. The result of this scenario may be a home team win 84% and overtime 5.6%. The home team may further have a 50% chance to win overtime, so the final output may be: 0.84+(0.056+0.5)=0.868. This may be determined by the LWP module 206. The LWP module 206 may output the odds of winning in regulation/losing in regulation/going to overtime. The predicted output of this (and the output of the other examples) may incorporate the +0.5 because if the odds of winning in overtime is 50/50, the LWP module 206 may add 50% of the probability of going to overtime to the probability of winning in regulation

In scenario B, the predicted outcome of the fourth down play may be 4th Qtr 6:20, home team up by 4, score total 36, 1st & 10, 40 Yards From Goal, Away team has the ball. A turnover on downs may have just occurred. In this scenario the possession may change from the offense to the defense. The internal models (e.g., by the go-for-it-success next yards module 224) may have the outcome yards from goal be set to (100-current yards from goal) assuming that no yards occurred on the fourth down attempt. Down and yards to go may be set to 1^{st} and 10. The result of this scenario may be that the home team's win percentage is 52.3% and overtime is 5.4%. The final output (e.g., by the LWP module 206) may be: 0.523+(0.054+0.5)=0.55.

In scenario C, the predicted outcome of the fourth down play may be 4th Qtr 6:20, home team up by 7, score total 39, Kick off, Away team has the ball. A successful field goal may have just occurred. The home team has the ball changed from 1 to 0, indicating that a chance in possession has occurred after the kick. The kick off value may change from 0 to 1. Down, yards to go, and yards from goal may be set to null (e.g., by the go-for-it-success next yards module 224). The score difference and total may be increased by 3. The result of this scenario may be that the home team wins 81.1% and overtime 10.7%. The output (e.g., by the LWP module 206) may be: 0.811+(0.107*0.5)=0.865.

In scenario D, the predicted outcome of the fourth down play may be 4th Qtr 6:20, home team up by 4, score total 36, 1st & 10, 33 Yards From Goal, Away team has the ball. A field goal attempt may have been failed (e.g., as predicted by the field goal success probability module 224). The home team may have the ball changed from 1 to 0. The outcome yards from goal may be set to (100-current yards from goal-7). The -7 may be input because typically teams kick the ball about 7 yards behind the line of scrimmage and the ball is placed where the team kicks the ball from. The down and yards may be set to 1^{st} and 10. The result of the scenario may be that the home team win % is 52.6% and OT is 5.5%. The output (e.g., by the LWP module 206) may be: 0.526+(0.055*0.05)=0.554.

In scenario E, the predicted outcome of the fourth down play may be 4th Qtr 6:20, home team up by 4, 1st & 10, 80 Yards From Goal, Away team has the ball. The offensive team may have punted the ball. The home team may have the ball changed from 1 to 0. The result of the punt field position may be set to 80 yards (e.g., as predicted by the punt field position module 220). The downs and yards may be set to 1^{st} and 10. The results of this scenario may give the home team a 66.7% chance of winning and a 4.8% chance of overtime. The output (e.g., by the LWP module 206) may be: 0.667+(0.048*0.5)=0.691.

To Summarize, scenario A-C may be predicted by the go-for-it success next yard module. Scenario D may be predicted by the field goal success probability module 22. Scenario E may be predicted by the punt filed position module 220. Each of these module's output may then be sent to the fourth down predictor 216.

The fourth down predictor 216 may determine the following where the play description is 4^{th} Qtr 6:20, home team up by 4, score total 36, 4th & 9, 60 Yards From Goal, Home team has the ball.

The fourth down predictor 216 may determine the probability of a successful first down conversion and field goal attempt. This may be calculated using the initial modules (e.g., the play probability module 210) and the punt field position module 220, the field goal success probability module 222, and the go-for-it success next yard module 224 respectively. The outputs from the play probability module 210 may be displayed in table 4 below.

TABLE 4

| field_goal_made | field_goal_missed | first_down | none | touchdown | punt | turnover |
|---|---|---|---|---|---|---|
| 0.000009 | 0.000012 | 0.002967 | 0.005019 | 0.000256 | 0.985814 | 0.005923 |

As field goal made/missed and punts are not attempts to go for it, these values may be subtracted. As these situations are not examples of the team electing to go for it, they may not be included in this calculation. The equation may be: (first down+touchdown)/(1−field goal made−field goal missed−punt). This may apply as: 0.002967+0.000256)/(1−0.000009−0.000012−0.985814)≈0.228. The output of 22.8% may represent the odds of a team being successful if they attempt the fourth down. As there are no fail/success option for a punt, the value from the scenario E may be utilized. For the field goal probability, the output of the field goal success probability may be input which in this case may be 0.016. The fourth down predictor may determine the following win % as depicted in table 5: Win %=“Win % if Success”*“Success %”+(1−“Success %”)*“Win % if Fail”; the go for it decision win percentage may become: (0.868*0.228)+(0.55*(1−0.228))=0.622; the field goal decision win percentage may become: (0.865*0.016)+(0.554*(1−0.016))=0.559

TABLE 5

| | | Success | Win % if | Win % if |
|---|---|---|---|---|
| Decision | Win % | % | Fail | Success |
| Go For it | 62.2% | 22.8% | 55.0% | 86.8% |
| Field Goal | 55.9% | 1.6% | 55.4% | 86.5% |
| Attempt | | | | |
| Punt | 69.1% | | | |

An example scenario for the two-point predictor 218 may be as follows. The following play may have just occurred: 4th Qtr 0:57, Home up by 2, Point After Touchdown, home may have the ball. The two-point conversion module 228 may determine a probability of success and a probability of failure along with adjusted LWP module 206 outcomes. If successful, the probability=0.527, where 4th Qtr 0:57, Tied, Kick Off, away has ball (LWP=0.459). If failed, the probability=0.473, where 4th Qtr 0:57, Home up by 2, Kick Off, away has ball (LWP=0.098). The two-point conversion module 228 may determine a probabilities of success and probability of failure along with adjusted LWP module 206 outcomes. If successful, the probability=0.937, where 4th Qtr 0:57, Home up by 1, Kick Off, away has ball (LWP=0.1). If unsuccessful, the probability=0.063, where 4th Qtr 0:57, Home up by 2, Kick Off, away has ball (LWP=0.098). The two-point predictor 218, may output the following Table 6, where the win % column is calculated by: Win %=“Win % if Success”*“Success %”+(1−“Success %”)*“Win % if Fail”.

TABLE 6

| | | Success | Win % if | Win % if |
|---|---|---|---|---|
| Decision | Win % | % | Fail | Success |
| Go For Two | 28.8% | 52.7% | 9.8% | 45.9% |
| Kick XP | 10.0% | 93.7% | 9.8% | 10.0% |

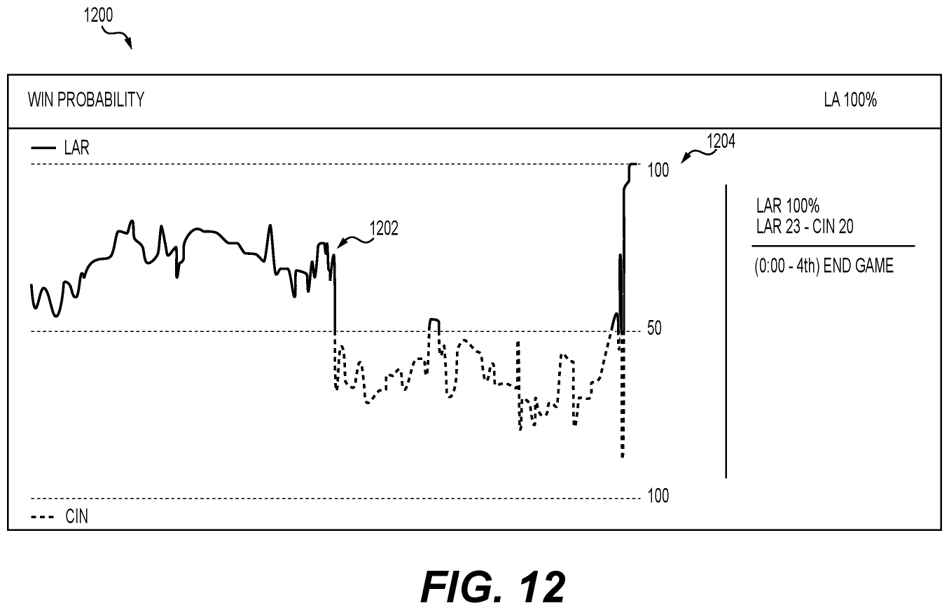

In some instances, many live win-probability models may only give a likelihood of a team winning or losing. FIG. 12 is an example live win-probability output over time 1200. As shown in FIG. 12, the trend line 1202 can illustrate a predicted probability 1204 of each team winning at each time instance. The model can incorporate in-game data along with other parameters to determine a probability of either team winning.

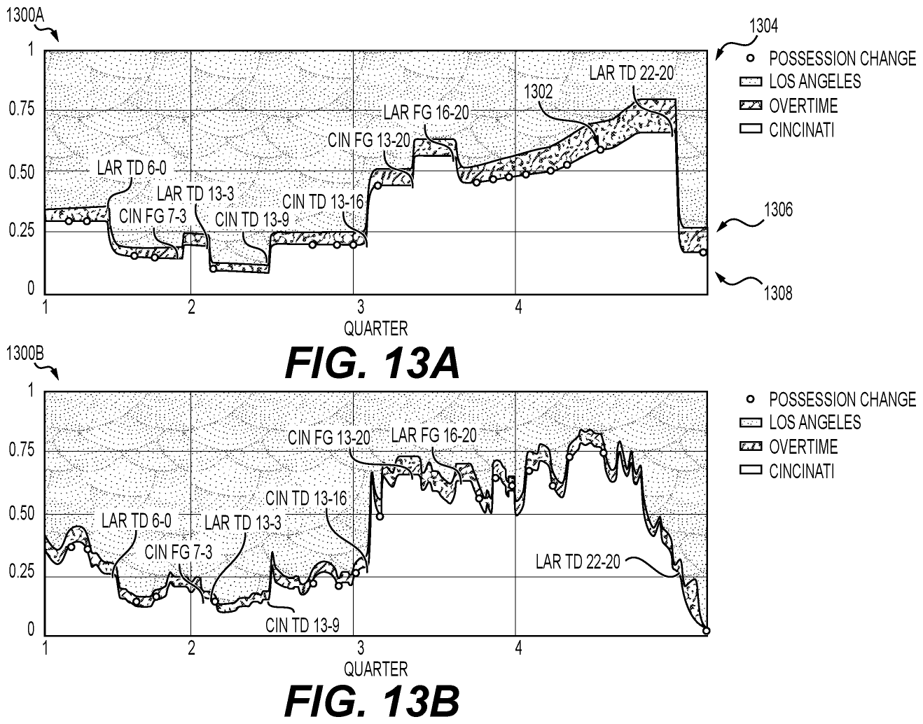

FIGS. 13A-13B illustrate example outputs depicting drive and play contextual data during a game. For example, in FIG. 13A, a first output 1300A can depict probabilities of various outcomes. For instance, the output 1300A can include each possession change 1302, and a probability of the game being won by a first team 1304, a second team 1308, and the game going into overtime 1306. The output 1300B in FIG. 13B can illustrate example probabilities with a drive and/or play context. As shown in FIGS. 13A-13B, incorporating drive/play contextual information can increase the accuracy of generating probabilities of each output during the course of the game.

Additionally, many models are incapable of predicting a final score spread and/or a total score in a game as part of its live prediction. This is typically attributed to the difficulty in accurately predicting a final score spread or the final score in real-time or near real-time as the game progresses. By training a model to include more robust features, such as a drive or play predictions (or “super features”), the model can more accurately generate a final score spread and a total score in-game.

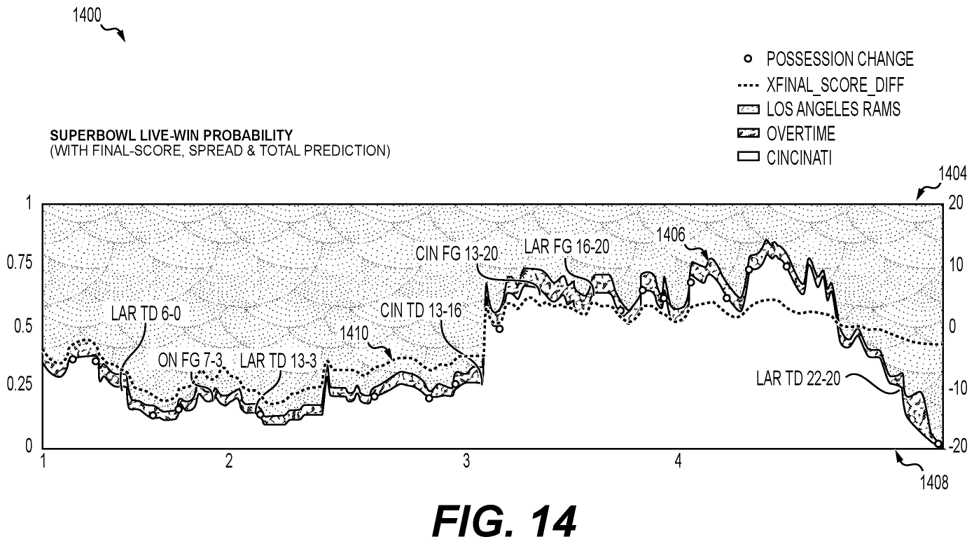

FIG. 14 is an example output of a live-win probability model. As shown in FIG. 14, the output 1400 can illustrate a probability of a first team winning 1404, the game going into overtime 1406, the second team winning 1408 over the course of the game. Further, the output 1400 can include a final score differential predictor 1410 representing a score differential of the game over the course of the game. In some instances, the output can also include a projected total score and final score for the game.

Further, existing live win probability models are incapable of generating probabilities related to specific scenarios, such as fourth down scenarios (e.g., a fourth down bot) and go-for-two scenarios. By providing a fourth down predictor and/or a go-for-two predictor as part of a suite of models associated with a live win probability model, the outputs generated by the live win probability model can be further enhanced.

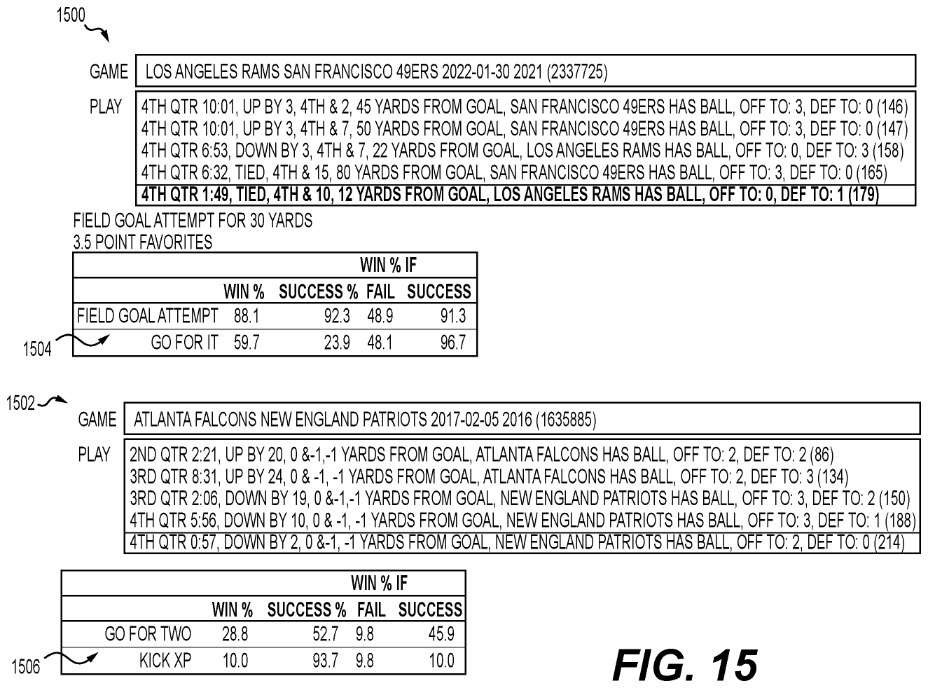

FIG. 15 illustrates an example fourth down predictor 1500 (e.g., a fourth down predictor 216 as depicted in FIG. 2A) and a go-for-two predictor 1502 (e.g., a two-point predictor 218 as depicted in FIG. 2A). As shown in FIG. 15, a fourth down predictor 1500 can obtain game data and play data to determine a percentage of whether a team will attempt a field goal (or punt) or go for it. The fourth down predictor 1500 can output 1504 various probabilities, such as a probability of success for attempting a field goal or going for it, as well as a win percentage based on failure/success of each action.

Further, a go-for-two predictor 1502 can output 1506 a probability of going for two or kicking an extra point. The output 1506 can further specify a probability of success of each action and a winning percentage for each action taken. FIG. 9C

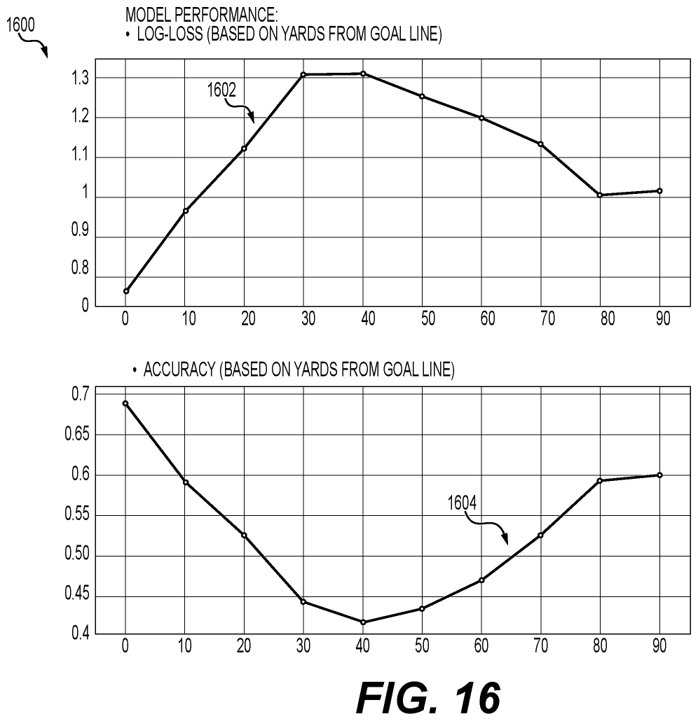

FIG. 16 is an example output 1600 illustrating model performance of the drive probability model. As shown in FIG. 16, the output 1600 can include trendlines 1602, 1604 for log-loss and accuracy based on yards from the goal line.

The model (e.g., drive prediction model) can obtain pre-game odds, pre-game score-totals and spread. This data can capture relative team strength & relative off/def performances for the game. The raw data obtained during the game can include time-left (e.g., half, and time left in half), current total, and difference (positive is home team leading), down and distance, timeout's left (for home, and away), team in possession (1 for home, 0 for away).

The targets for the model can include drive outcomes, such as clock (end of 2nd or 4th quarter), field goal made, field goal missed, punt, safety, touch down, turnover, and/or turnover on downs. The dataset for training the model can include regulation plays from scrimmage that counted (i.e., not waved off by a penalty) with various training data from previous games. The model parameters can include a random forest classifier with 150 trees, a max depth of 14, a minimum samples leaf of 4, a minimum sample split of 10, and bootstrap=false.

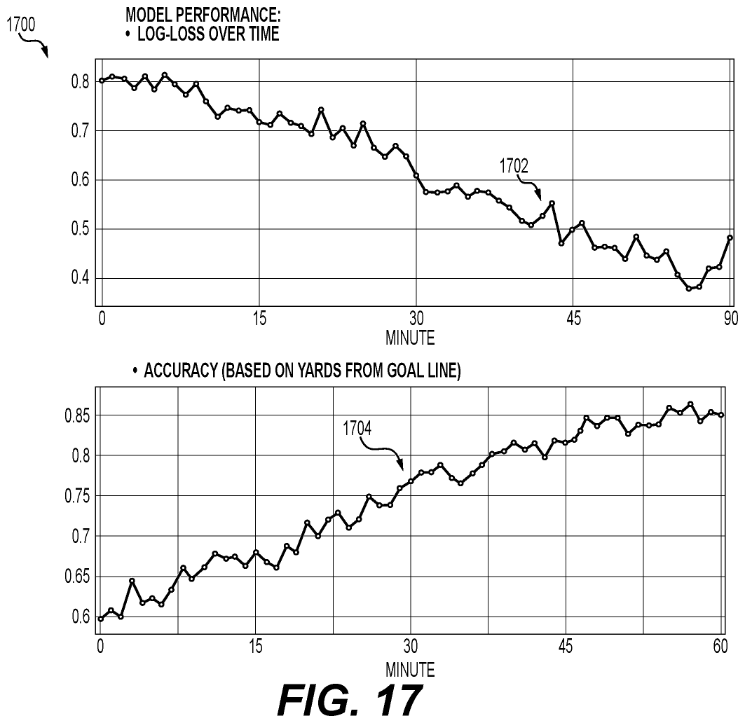

FIG. 17 is an example output 1700 for a model performance of a live win probability model. As shown in FIG. 17, the output 1700 can specify trend lines 1702, 1704 for model performance with log-loss over time and accuracy over time.

The model can obtain pre-game data such as pre-game odds, pre-game score totals, and spread. During the game, raw data can include time-left (half, and time left in half), current total, and difference (positive is home team leading), down and distance, timeouts left (for home, and away), team in possession (1 for home, 0 for away), binary values for point after and kickoff. Predicted data within the game can include drive probability from the drive prediction model and/or a first down prediction from the play outcome probability model.

The dataset can include a number of games and samples over time. Further, model parameters can include a tanh activation, hidden layer sizes of (10, 30, 10), early stopping=true, and n_iter_no_change of 5.

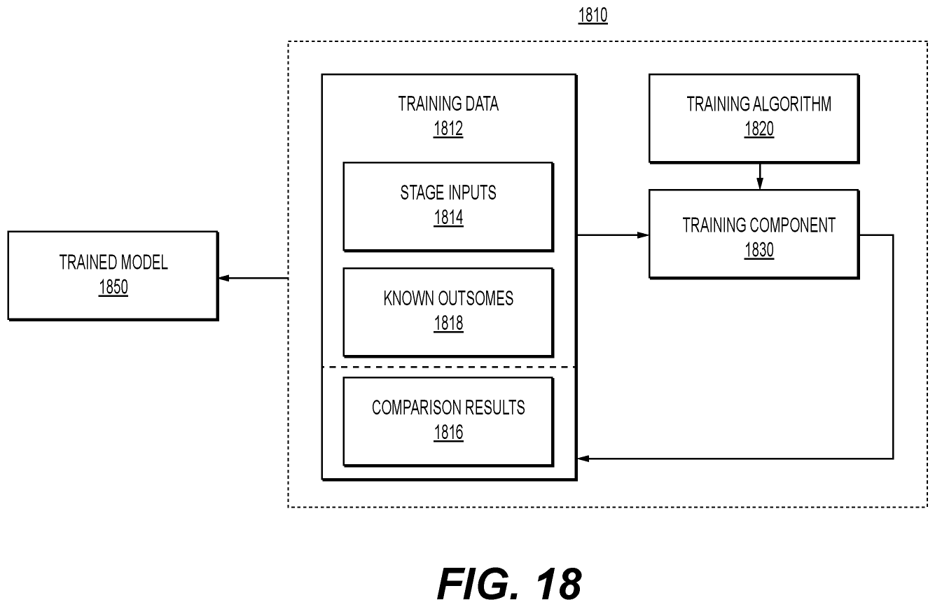

FIG. 18 depicts a flow diagram 1810 for training a machine learning model, in accordance with an aspect. As shown in flow diagram 1810 of FIG. 18, training data 1812 may include one or more of stage inputs 1814 and known outcomes 1818 related to a machine learning model to be trained. The stage inputs 1814 may be from any applicable source including a component or set shown in the figures provided herein. The known outcomes 1818 may be included for machine learning models generated based on supervised or semi-supervised training. An unsupervised machine learning model might not be trained using known outcomes 1818. Known outcomes 1818 may include known or desired outputs for future inputs similar to or in the same category as stage inputs 1814 that do not have corresponding known outputs.

The training data 1812 and a training algorithm 1820 may be provided to a training component 1830 that may apply the training data 1812 to the training algorithm 1820 to generate a trained machine learning model 1850. According to an implementation, the training component 1830 may be provided comparison results 1816 that compare a previous output of the corresponding machine learning model to apply the previous result to re-train the machine learning model. The comparison results 1816 may be used by the training component 1830 to update the corresponding machine learning model. The training algorithm 1820 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 1810 may be a trained machine learning model 1850.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

FIG. 19 is a simplified functional block diagram of a computer 1900 that may be configured as a device for executing the methods disclosed here, according to exemplary aspects of the present disclosure. For example, the computer 1900 may be configured as a system according to exemplary aspects of this disclosure. In various aspects, any of the systems herein may be a computer 1900 including, for example, a data communication interface 1920 for packet data communication. The computer 1900 also may include a central processing unit (“CPU”) 1902, in the form of one or more processors, for executing program instructions. The computer 1900 may include an internal communication bus 1908, and a storage unit 1906 (such as ROM, HDD, SDD, etc.) that may store data on a computer readable medium 1922, although the computer 1900 may receive programming and data via network communications 1925.

The computer 1900 may also have a memory 1904 (such as RAM) storing instructions 1924 for executing techniques presented herein, for example the methods described with respect to FIG. 3, although the instructions 1924 may be stored temporarily or permanently within other modules of computer 1900 (e.g., processor 1902 and/or computer readable medium 1922). The computer 1900 also may include input and output ports 1912 and/or a display 1910 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating coupled play, drive, and game outcome predictions for a sporting event, the method comprising:
inputting features for a sporting event into an initial model, the input features including historical game data and in-game data;
determining a predicted outcome for at least one upcoming play with the initial model;
determining, using the input features and predicted outcome, a predicted probability of each team winning the sporting event; and
determining a probability of success for an action in the at least one upcoming play of the sporting event.

2. The method of claim 1, wherein the in-game data comprises at least one of a time left for a remaining portion of the sporting event, a current point total, a current point differential, a current down and distance to go, a number of timeouts remaining, and/or a team in possession.

3. The method of claim 1, wherein the historical game data includes a repository of historical team and player data for one or more sporting events.

4. The method of claim 1, wherein the input model includes:
a play probability model, the play probability model being configured to predict a probability of a particular play outcome occurring in the sporting event;
a drive score probability model, the drive score probability model being configured to generate a probability of a particular score outcome occurring on a drive in the sporting event; and
a drive remaining model, the drive remaining model being configured to predict a number of remaining drives for each team in the sporting event.

5. The method of claim 4, wherein the predicted outcome includes: the probability of the particular play outcome occurring in the sporting event, the probability of the particular score outcome occurring on the drive in the sporting event, and/or the predicted number of remaining drives for each team in the sporting event.

6. The method of claim 5, wherein the predicted outcome for at least one upcoming play includes each of a set of play outcomes and a corresponding probability of each of the set of play outcomes being performed based on a current down and yardage from a first down.

7. The method of claim 5, wherein predicted outcome for the drive includes each of a set of drive outcomes and a corresponding probability of each of the set of drive outcomes based on a number of yards from a goal line.

8. The method of claim 4, wherein the play probability model includes a random forest classifier, wherein the drive score probability model includes a multi-layer perceptron, and the drive remaining model includes a multi-layer perceptron.

9. The method of claim 4, further including:
generating an expected number of points to be scored on a particular drive in the sporting event using an expected points model, the expected points model using the outcome of the drive score probability model to generate the expected number of points.

10. The method of claim 4, wherein the probability of each team winning the sporting events is determined by a live win probability model, the live win probability model including a multi-layer perceptron, the live win probability model receiving outputs from the drive score probability model and drive remaining model.

11. The method of claim 1, wherein the sporting event is an American football game, wherein the at least one upcoming play is a two-point conversion in the American football game, and wherein the probability of success for the two-point conversion is determined by a two-point predictor, the two-point predictor performing the steps of:
identifying each of two potential actions capable of being performed, the two potential actions comprising performing an extra point kick and performing an offensive play after scoring of a touchdown;
deriving a success rate of each potential action using the predicted outcome for the at least one upcoming play; and
deriving an updated win percentage of each potential action using the predicted probability of each team winning, wherein the success rate and the updated win percentage of each potential action are used to update the predicted probability of each team winning.

12. The method of claim 1, wherein the sporting event is an American football game, wherein the at least one upcoming play is a fourth-down play in the American football game, and wherein the probability of success for the fourth-down play is determined by a fourth down model, the fourth down model performing the steps of:
identifying each of three potential actions capable of being performed, the actions comprising performing a punt, a field goal attempt, or performing an offensive play;
deriving a success rate of each potential action using the predicted outcome for the at least one upcoming play; and
deriving an updated win percentage of each potential action using the predicted probability of each team winning, wherein the success rate and the updated win percentage of each potential action are used to update the predicted probability of each team winning.

13. The method of claim 1, further comprising:
obtaining updated in-game data during the sporting event; and
updating the predicted outcome of the sporting event.

14. A system for generating coupled play, drive, and game outcome predictions for a sporting event, the system comprising:
a non-transitory computer readable medium configured to store processor-readable instructions; and
a processor operatively connected to the non-transitory computer readable medium, and configured to execute the instructions to perform operations comprising:
inputting features for a sporting event into an initial model, the input features including historical game data and in-game data;
determining a predicted outcome for at least one upcoming play with the initial model;
determining, using the input features and predicted outcome, a predicted probability of each team winning the sporting event; and
determining a probability of success for an action in the at least one upcoming play of the sporting event.

15. The system of claim 14, wherein the in-game data comprises at least one of a time left for a remaining portion of the sporting event, a current point total, a current point differential, a current down and distance to go, a number of timeouts remaining, and/or a team in possession.

16. The system of claim 14, wherein the historical game data includes a repository of historical team and player data for one or more sporting events.

17. The system of claim 14, wherein the input model includes:
a play probability model, the play probability model being configured to predict a probability of a particular play outcome occurring in the sporting event;
a drive score probability model, the drive score probability model being configured to generate a probability of a particular score outcome occurring on a drive in the sporting event; and
a drive remaining model, the drive remaining model being configured to predict a number of remaining drives for each team in the sporting event.

18. The system of claim 17, wherein the predicted outcome includes: the probability of the particular play outcome occurring in the sporting event, the probability of the particular score outcome occurring on the drive in the sporting event, and/or the predicted number of remaining drives for each team in the sporting event.

19. A non-transitory computer readable medium configured to store processor-readable instructions, wherein when executed by a processor, the instructions perform operations comprising:
inputting features for a sporting event into an initial model, the input features including historical game data and in-game data;
determining a predicted outcome for at least one upcoming play with the initial model;
determining, using the input features and predicted outcome, a predicted probability of each team winning the sporting event; and
determining a probability of success for an action in the at least one upcoming play of the sporting event.

20. The non-transitory computer readable medium of claim 19, wherein the input model includes:
a play probability model, the play probability model being configured to predict a probability of a particular play outcome occurring in the sporting event;
a drive score probability model, the drive score probability model being configured to generate a probability of a particular score outcome occurring on a drive in the sporting event; and
a drive remaining model, the drive remaining model being configured to predict a number of remaining drives for each team in the sporting event.
